(19) United States
(12) Patent Application Publication
(10) Pub. No.: US 2023/0124466 A1
(43) Pub. Date: Apr. 20, 2023

(54) INFORMATION PROCESSING APPARATUS, INFORMATION PROCESSING METHOD, AND INFORMATION PROCESSING PROGRAM

(71) Applicant: SONY GROUP CORPORATION, Tokyo (JP)

(72) Inventor: Kazuhiro SHIMAUCHI, Tokyo (JP)

(73) Assignee: SONY GROUP CORPORATION, Tokyo (JP)

(21) Appl. No.: 17/908,770

(22) PCT Filed: Mar. 5, 2021
(86) PCT No.: PCT/JP2021/008779

§ 371 Date: Sep. 1, 2022

(30) Foreign Application Priority Data
Mar. 27, 2020 (JP) 2020-058989

(51) Int. Cl. G06T 11/60; G06V 20/50; G06V 40/20; G06T 7/70; G06V 20/62

(52) U.S. Cl. CPC G06T 11/60; G06V 20/50; G06V 40/20; G06T 7/70; G06V 20/63; G06T 2207/30196; G06T 2210/22; G06T 2210/62

(57) ABSTRACT

An information processing apparatus includes a control unit configured to generate display control information used as information regarding display control of a display image corresponding to scene information indicating a scene of a seminar.

### TECHNICAL FIELD

The present disclosure relates to an information processing apparatus, an information processing method, and an information processing program.

### BACKGROUND ART

Techniques of capturing and recording the circumstance of a presentation at a seminar or other event and creating a video including the instructor's video and presentation materials are known.

In one example, Patent Document 1 discloses a technique of changing the layout of a video that includes a person and materials, depending on the person's position giving commentary on the materials.

### CITATION LIST

### PATENT DOCUMENT

Patent Document 1: Japanese Patent Application Laid-Open No. 2014-175941

### SUMMARY OF THE INVENTION

### Problems To Be Solved by the Invention

It is desirable to generate an appropriate video corresponding to the scenes of a seminar.

Thus, the present disclosure provides an information processing apparatus, information processing method, and information processing program capable of generating an appropriate video corresponding to the scenes of a seminar.

### Solutions to Problems

An information processing apparatus of one embodiment according to the present disclosure includes a control unit that generates display control information, which is information regarding display control of a display image corresponding to scene information indicating the scenes of a seminar.

### BRIEF DESCRIPTION OF DRAWINGS

FIG. 1 is a diagram illustrated to describe an overview of an information processing system according to an embodiment.

FIG. 2 is a block diagram illustrating an exemplary configuration of an information processing apparatus according to an embodiment.

FIG. 3 is a diagram illustrated to describe a person with a posture estimated by a posture estimation unit.

FIG. 4 is a diagram illustrated to describe how to estimate a person's posture by the posture estimation unit.

FIG. 5 is a diagram illustrated to describe how to estimate a person's facial expression by the posture estimation unit.

FIG. 6 is a diagram illustrated to describe cropping processing by a cropping unit.

FIG. 7A is a diagram illustrated to describe a first example of a side-by-side arrangement.

FIG. 7B is a diagram illustrated to describe a second example of a side-by-side arrangement.

FIG. 8A is a diagram illustrated to describe a first example of a display image in a picture-in-picture arrangement.

FIG. 8B is a diagram illustrated to describe a second example of a display image in a picture-in-picture arrangement.

FIG. 8C is a diagram illustrated to describe a third example of a display image is a picture-in-picture arrangement.

FIG. 8D is a diagram illustrated to describe a fourth example of a display image in a picture-in-picture arrangement.

FIG. 9A is a diagram illustrated to describe a first example of a display image in an extraction arrangement.

FIG. 9B is a diagram illustrated to describe a second example of a display image is an extraction arrangement.

FIG. 10 is a diagram illustrated to describe an example of a transparent arrangement.

FIG. 11 is a flowchart illustrating an exemplary processing procedure of an information processing apparatus according to a first embodiment.

FIG. 12 is a block diagram illustrating a configuration of an information processing apparatus according to a second embodiment.

FIG. 13 is a flowchart illustrating an exemplary processing procedure of an information processing apparatus according to the second embodiment.

FIG. 14 is a block diagram illustrating a configuration of an information processing apparatus according to a third embodiment.

FIG. 15 is a diagram illustrated to describe the layout of a display image in a case of determining that a main subject is walking.

FIG. 16 is a flowchart illustrating an exemplary processing procedure of an information processing apparatus according to the third embodiment.

FIG. 17 is a block diagram illustrating a configuration of an information processing apparatus according to a fourth embodiment.

FIG. 18 is a diagram illustrated to describe the layout of a display image in the case of determining that a question-and-answer session holds.

FIG. 19 is a diagram illustrating an exemplary processing procedure of an information processing apparatus according to the fourth embodiment.

FIG. 20 is a diagram illustrating a first modification of the layout of a display image according to the fourth embodiment.

FIG. 21 as a diagram illustrating a second modification of the layout of a display image according to the fourth embodiment.

FIG. 22 is a diagram illustrating a third modification of the layout of a display image according to the fourth embodiment.

FIG. 23 is a diagram illustrating a fourth modification of the layout of a display image according to the fourth embodiment.

FIG. 24 is a diagram illustrating a fifth modification of the layout of a display image according to the fourth embodiment.

FIG. 25 is a flowchart illustrating an example of the procedure of a modification of processing of the information processing apparatus according to the fourth embodiment.

FIG. 26 is a block diagram illustrating a configuration of an information processing apparatus according to a fifth embodiment.

FIG. 27 is a hardware configuration diagram illustrating as example of a computer that implements the functions of an information processing apparatus.

### MODE FOR CARRYING OUT THE INVENTION

Embodiments of the present disclosure are now described in detail with reference to the drawings. Moreover, in each embodiment below, the same components or parts are designated by the same reference numerals, so repetitive description is omitted.

Moreover, the description is given in the order below.

1. First Embodiment

1-1. Overview

1-2. Configuration of Information Processing Apparatus

1-3. Decision of Layout

1-3-1. Question-and-Answer Scene

1-3-2. Question Scene

1-3-3. Material Changeover Scene

1-3-4. Board Writing Scene

1-3-5. Commentary Scene

1-4. Layout of Display Image

1-4-1. Side-by-Side Arrangement

1-4-2. Picture-in-Picture Arrangement

1-4-3. Extraction Arrangement

1-4-4. Transparent Arrangement

1-4-5. Single Arrangement

1-5. Processing by Information Processing Apparatus

2. Second Embodiment

2-1. Configuration of Information Processing Apparatus

2-2. Processing by Information Processing Apparatus

3. Third Embodiment

3-1. Configuration of Information Processing Apparatus

3-2. Processing by Information Processing Apparatus

4. Fourth Embodiment

4-1. Configuration of Information Processing Apparatus

4-2. Processing by Information Processing Apparatus

4-3. Modification of Layout

4-4. Modification of processing by information processing apparatus

5. Fifth Embodiment

5-1. Configuration of Information Processing Apparatus

6. Hardware configuration

7. effects

### 1. First Embodiment

[1-1. Overview]

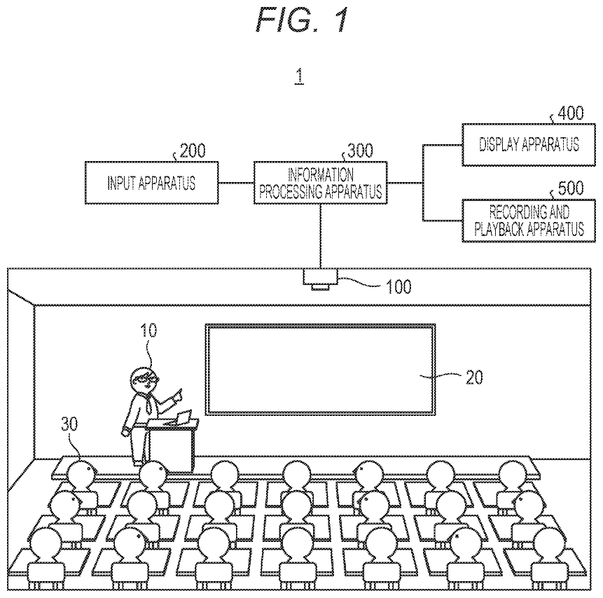

The overview of an information processing system according to an embodiment is described with reference to FIG. 1. FIG. 1 is a diagram illustrated to describe an overview of the information processing system according to an embodiment.

The information processing system 1 includes an image capturing apparatus 100, an input apparatus 200, an information processing apparatus 300, a display apparatus 400, and a recording and playback apparatus 500, as illustrated in FIG. 1. The image capturing apparatus 100, the input apparatus 200, the information processing apparatus 300, the display apparatus 400, and the recording and playback apparatus 500 can be connected to each other directly using a high-definition multimedia interface (HDMI, registered trademark), serial digital interface (SDI), or the like. The image capturing apparatus 100, the input apparatus 200, the information processing apparatus 300, the display apparatus 400, and the recording and playback apparatus 500 can be connected to each other over a wired or wireless network. The information processing system 1 performs capturing of the circumstance of a seminar, real-time delivery, or recording with the recording and playback apparatus 500. An example of a seminar includes herein various lectures, lessons, talk shows, training, and the like.

The image capturing apparatus 100 is arranged at a place where a seminar is held and captures the circumstance of the seminar. The image capturing apparatus 100 is implemented by, for example, a bird's-eye view camera that captures the entire venue of a seminar. The image capturing apparatus 100 can include, for example, a plurality of cameras and can have a configuration of capturing the entire seminar venue with the plurality of cameras. The image capturing apparatus 100 can be a camera that captures a high-resolution video of 4K, 8K, or higher resolution. The image capturing apparatus 100 can be provided with a microphone to collect the voice from the venue of a seminar. The image capturing apparatus 100 captures a main subject 10, a presenting object 20, and a secondary subject 30. The main subject 10 is instructor, presenter, lecturer, or like personnel in the case where a seminar is a lecture or a class. The main subject 10 is a presenter, promoter, speaker, guest of honor, or equivalent personnel in the case where a seminar is a talk show or the like. The presenting object 20 is an object presented by the main subject 10. The presenting object 20 is, for example, seminar-related materials projected on a screen by a projector or other equipment. The presenting object 20 can be, for example, the writing by board writing on a blackboard, whiteboard, or touch panel that is writable by the main subject 10. The secondary subject 30 is, for example, a student, participant, auditing participant, or members who attend a seminar. The image capturing apparatus 100 outputs a captured image obtained by capturing the main subject 10, the presenting object 20, and the secondary subject 30 to the information processing apparatus 300.

The input apparatus 200 outputs information relating to the presenting object 20 used at a seminar to the information processing apparatus 300. The input apparatus 200 is, for example, a personal computer (PC) or the like in which materials used at a seminar by the main subject 10 are stored. The input apparatus 200 can be, for example, a projector that projects an image of materials of a seminar.

The information processing apparatus 300 determines a scene of a seminar on the basis of the captured image received from the image capturing apparatus 100. The information processing apparatus 300 determines a scene of a seminar on the basis of the captured image received from the image capturing apparatus 100 and the captured image received from the input apparatus 200. The information processing apparatus 300 generates scene information indicating a scene of a seminar. The information processing apparatus 300 generates display control information, which is information relating to the display control of a display image corresponding to the scene information. The display control information is herein information relating to display control of the display image corresponding to the scene information indicating the scene of a seminar. In other words, the display control information is information generated to control the display of the display image corresponding to the scene information. The display control information includes posture estimation information, scene information, tracking result-related information, and layout information. Various types of information are described in detail later. The display, control information can include any other information as long as it is the information used to control the display of the display image. Specifically, the information processing apparatus 300 generates a display image to be displayed on the display apparatus 400 depending on the scene of a seminar. The information processing apparatus 300 outputs the generated display image to the display apparatus 400 and the recording and playback apparatus 500.

The display apparatus 400 displays various images. The display apparatus 400 displays the display image received from the information processing apparatus 300. The user is able to recognize the contents of the seminar by viewing or listening to the display image. The display apparatus 400 includes a display device such as a liquid crystal display (LCD) or organic electro-luminescence (EL) display.

The recording and playback apparatus 500 records various types of videos. The recording and playback apparatus 500 records the display image received from the information processing apparatus 300. The user's playing back of the display image recorded on the recording and playback apparatus 500 allows the display image to be displayed on the display apparatus 400. This configuration makes it possible for the use to recognize the contents of a seminar.

[1-2. Configuration of Information Processing Apparatus]

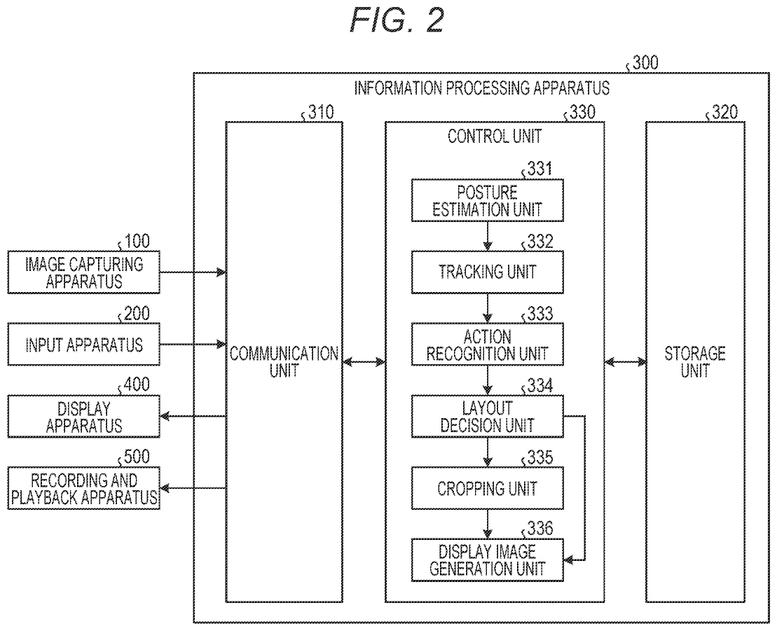

The configuration of the information processing apparatus according to an embodiment is described with reference to FIG. 2. FIG. 2 is a diagram illustrating an exemplary configuration of the information processing apparatus according to an embodiment.

The information processing apparatus 300 includes a communication unit 310, a storage unit 320, and a control unit 330, as illustrated in FIG. 2.

The communication unit 310 is a communication circuit that allows the information processing apparatus 300 to input or output a signal from or to an external device. The communication unit 310 receives a captured image from the image capturing apparatus 100. The communication unit 310 receives seminar materials-related information from the input apparatus 200. The communication unit 310 outputs the display image generated by the information processing apparatus 300 to the display apparatus 400 and the recording and playback apparatus 500.

The storage unit 320 stores various types of data. The storage unit 320 can be implemented by, for example, a semiconductor memory device such as random-access memory (RAM) and flash memory or a storage device such as a hard disk and solid-state drive.

The control unit 330 is implemented by, for example, a central processing unit (CPU), micro processing unit (MPU), graphics processing unit (GPU), or the like, which enables a program (e.g., an information processing program according to the present disclosure) stored in a storage unit (not illustrated) to be running on RAM or the like as a work area. The control unit 330 can be implemented by an integrated circuit such as an application-specific integrated circuit (ASIC) or field-programmable gate array (FPGA). The control unit 330 can be implemented by combined hardware and software.

The control unit 330 includes a posture estimation unit 331, a tracking unit 332, an action recognition unit 333, a layout decision unit 334, a cropping unit 335, and a display image generation unit 336.

The posture estimation unit 331 estimates the posture of a person included in the captured image received from the image capturing apparatus 100. The posture of the person includes skeleton information. Specifically, the posture estimation unit 331 estimates the posture of the person on the basis of the positions of joints and bones included in the skeleton information.

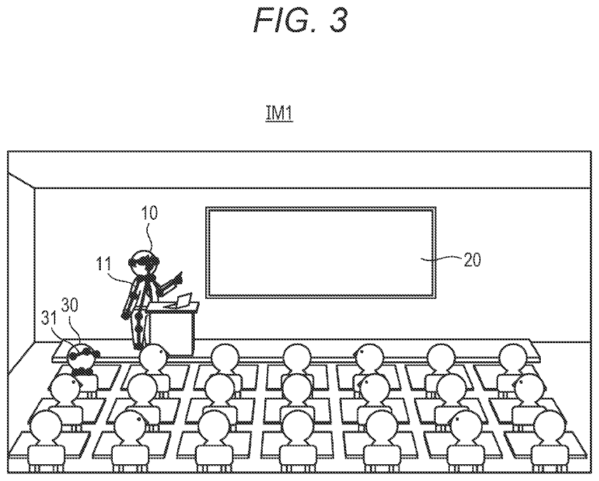

FIG. 3 is a diagram illustrated to describe a person with a posture estimated by the posture estimation unit 331. FIG. 3 illustrates a captured image IM1 obtained by capturing the circumstance of a seminar by the image capturing apparatus 100. The captured image IM1 includes the main subject 10 and a plurality of the secondary subjects 30. In FIG. 3, the main subject 10 is an instructor in a seminar, and the secondary subject 30 is a participant in the seminar. The posture estimation unit 331 estimates the posture of the main subject 10. The posture estimation unit 331 estimates the posture of the secondary subject 30. The posture estimation unit 331 can estimate the posture of one person of a plurality of secondary subjects 30, or can estimate the posture of all of them. The posture estimation unit 331 estimates skeleton information 11 indicating the skeleton of the main subject 10 to estimate the posture of the main subject 10. The posture estimation unit 331 estimates skeleton information 31 indicating the skeleton of the secondary subject 30 to estimate the posture of the secondary subject 30.

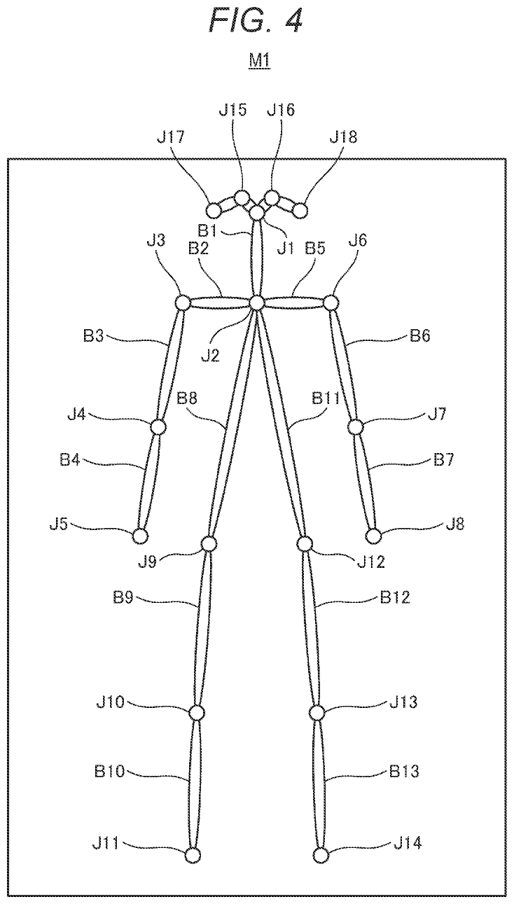

FIG. 4 is a diagram illustrated to describe how to estimate a person's posture by the posture estimation unit 331. FIG. 4 illustrates a skeleton model M1 indicating the skeleton information of a person. The posture estimation unit 331 estimates the skeleton information 11 of the main subject 10 and the skeleton information 31 of the secondary subject 30 as the skeleton model M1 illustrated in FIG. 4.

The skeleton model M1 includes joints J1 to J18 and bones B1 to B13 connecting the joints. The joints J1 and J2 correspond to the neck of a person. The joints J3 to J5 correspond to the right arm of a person. The joints J6 to J8 correspond to the left arm of the person. The joints J9 to J11 correspond to the right foot of the person. The joints J12 to J14 correspond to the left foot of the person. The joints J15 to J18 correspond to the head of a person.

The posture estimation unit 331 estimates the positions of the joints and bones of each of the main subject 10 and the secondary subject 30, as illustrated in FIG. 4. The posture estimation unit 331 estimates the postures of the main subject 10 and the secondary subject 30 on the basis of The positions of the joints and the bones. The posture estimation unit 331 outputs posture estimation information relating to the estimated postures of the main subject 10 and the secondary subject 30 to the tracking unit 332. The posture estimation unit 331 can estimate the facial expressions of the main subject 10 and the secondary subject 30.

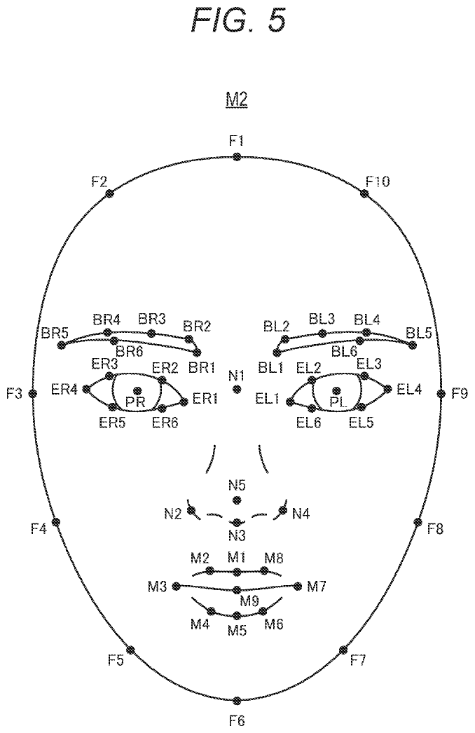

FIG. 5 is a diagram illustrated to describe how to estimate a person's facial expression by the posture estimation unit 331. FIG. 5 illustrates a facial model M2 indicating a person's face. The facial model M2 includes feature points F1 to F10 of the contour of the face. The facial model M2 includes feature points BR1 to BR6 of the right eyebrow. The facial model M2 includes feature points BL1 to BL6 of the left eyebrow. The facial model M2 includes feature points ER1 to ER6 of the contour of the right eye and a feature point PR of the right eye pupil. The facial model M2 includes feature points EL1 to EL6 of the contour of the left eye and a feature point PL of the left eye pupil. The facial model M2 includes feature points N1 to N5 of the nose. The facial model M2 includes feature points M1 to M9 of the mouth.

The posture estimation unit 331 estimates facial expressions of the main subject 10 and the secondary subject 30 on the basis of the position or motion of the facial contour, right eyebrow, left eyebrow, right eye contour, right eye pupil, left eye contour, left eye pupil, and mouth, as illustrated in the facial model M2. The posture estimation unit 331 outputs facial-expression estimation data relating to the estimated facial expressions of the main subject 10 and the secondary subject 30 to the tracking unit 332.

Referring back to FIG. 2, the tracking unit 332 receives the captured image obtained by capturing with the image capturing apparatus 100 and the posture estimation information from the posture estimation unit 331. The tracking unit 332 tracks the main subject 10 and the secondary subject 30 included in the captured image. Specifically, in the case where the main subject 10 or the secondary subject 30 moves across frames of the captured image, the tracking unit 332 tracks the subject moved across frames. This configuration makes it possible to obtain data in which the main subject 10 and the secondary subject 30 are identified individually in the captured image. The tracking unit 332 only required to, for example, track the main subject 10 and the secondary subject 30 using techniques in the related are such as moving-body detection processing. The tracking unit 332 can discriminate the color of the clothes of the main subject 10 and the secondary subject 30 to track the main subject 10 and the secondary subject 30 on the basis of the discriminated color of the clothes. The tracking unit 332 can track the movement of the main subject 10 and the secondary subject 30 by using only the posture estimation information received from the posture estimation unit 331. The tracking unit 332 can track the movement of the main subject 10 and the secondary subject 30 using only the captured image received from the image capturing apparatus 100. The tracking unit 332 can track the movement of the main subject 10 and the secondary subject 30 by using both the captured image and the posture estimation information. The tracking unit 332 outputs information relating to the cracking result to the action recognition unit 333.

The tracking unit 332 can add an attribute of each of the main subject 10 and the secondary subject 30 that are tracking targets. In one example, in a case where the facial image of the main subject 10 matches the facial image of a lecturer registered in advance in the storage unit 320, the tracking unit 332 can add, to the main subject 10, the attribute of the lecturer to be a tracking target. The tracking unit 332 can add, for example, the attribute of the participant to other persons than a person determined to be a lecturer. The tracking target can be set by the user on the basis of the captured image. Each attribute can be set by the user on the basis of the captured image.

The action recognition unit 333 determines the scene of a seminar on the basis of a captured seminar image obtained by capturing with the image capturing apparatus 100. The action recognition unit 333 generates the scene information depending on a result obtained by the determination of the scene. The action recognition unit 333 determines, as the scene of a seminar, the posture direction of a lecturer and a participant. The action recognition unit 333 determines, as the scene of a seminar, whether or not a lecturer is giving a commentary, the lecturer is walking, materials are changing into another, materials projected on a screen are sent to a slide, the lecturer is written on a board, and a question-and-answer session is being conducted. The action recognition unit 333 outputs the scene information relating to the determined scene to the layout decision unit 334.

The layout decision unit 334 decides on the layout of the display image on the basis of the determination result of the scene information by the action recognition unit 333. The layout decision unit 334 decides on the layout of the display image on the basis of, for example, a table in which the scene information is associated with the layout. The table is stored in the storage unit 320. The layout decision unit 334 decides on a configuration image, which is an image constituting at least a part of the display image, on the basis of the scene information. The layout decision unit 334 generates layout information indicative of the layout of the display image. The layout information can include information indicative of the configuration image.

The configuration image refers herein to an image that constitutes at least a part of the display image. In other words, the layout decision unit 334 decides on the layout of the display image from one or more configuration images. The configuration images include various types of images captured by the image capturing apparatus 100 of a seminar. Specifically, the configuration image includes an image of the main subject 10, an image having the presenting object 20, and an image of the secondary subject 30, which are captured by the image capturing apparatus 100 as a subject of a seminar. An image obtained by capturing at least one of the main subject 10 or the secondary subject 30 as a subject is also called a person image.

The person image includes a whole image that is a bird's-eye view image and a noticed image that is a close-up view image of a particular person. Specifically, an example of the whole image includes an entire image incorporating the main subject 10 as a subject (a whole image with the main subject 10) and an entire image incorporating the secondary subject 30 as a subject (a whole image with the secondary subject 30). In one example, the whole image with the main subject 10 is a bird's-eye view image including the main subject 10 and the secondary subject 30. The secondary subjects 30 incorporated in the whole image with the main subject 10 are unlimited in the number of persons included. The whole image with the main subject 10 is possible not to include the secondary subject 30. The whole image with the secondary subject 30 is a bird's-eye view image with a plurality of secondary subjects 30. The whole image with the secondary subject 30 can be a bird's-eye view image having only one person in the secondary subject 30.

The noticed image includes an image captured of the main subject 10 at close range or an image captured of the secondary subject 30 at close range. The close-up image of the secondary subject 30 is a close-up image of a particular secondary subject 30. The image of the presenting object 20 is also called a presenting object image. The presenting object image includes a seminar-related material image projected on the screen by a projector or the like. The presenting object image includes a writing image having information relating to the board writing performed by the main subject 10 on a blackboard, white board, and touch panel. The writing image includes a captured image of a blackboard, a whiteboard, and a touch panel. The writing image includes an image indicating a writing result obtained by extracting the writing from the captured images of a blackboard, whiteboard, and touch panel.

The layout decision unit 334 decides on a display arrangement in the display image of the configuration image, which is an image constituting at least a part of the display image on the basis of the scene information. The layout decision unit 334 decides on the number of the configuration images, which are images constituting at least a part of the display image, on the basis of the scene information. The layout decision unit 334 decides on a close-up image of one configuration image as the layout of the display image. In one example, the layout decision unit 334 decides on the layout arranged a plurality of configuration images in combination. In the case of using a plurality of configuration images, the layout decision unit 334 decides on either parallel arrangement or superimposition arrangement as the layout. The parallel arrangement refers to an arrangement of a plurality of configuration images in parallel in a vertical or horizontal direction as viewed by the audience. The description herein is given of a side-by-side arrangement in which two configuration images are arranged side by side in parallel, but this arrangement is illustrative and does not limit the number of configuration images and the arrangement direction. The superimposition arrangement refers to an arrangement in which at least some of the configuration images are superimposed on each other. The superimposition arrangement includes picture-in-picture arrangement, extraction arrangement, and transparent arrangement. Examples of parallel arrangement and superimposition arrangement are described in detail later. In the case of using the display image having a plurality of configuration images, the layout decision unit 334 decides on the display arrangement of the person image on the basis of the direction of the posture of the person in the person image (a first display image) that is one of a plurality of the configuration images. In the case of the display image including at least the person image and a second configuration image, the layout decision unit 334 decides on the display arrangement in such a way than the direction of the posture of the person in the person image corresponds to the positional relationship of the center of the second configuration image relative to the position of the center of the person image in the display image. The second configuration image herein is, for example, an image of the presenting object 20 to be a commentary target. The layout decision unit 334 generates layout information indicative of the layout of the display image. The layout information can include information indicating the number of configuration images and the arrangement of the configuration images. In other words, the layout information can include various types of information used to generate the display image.

The layout decision unit 334 specifies a cropping position in the captured image used to generate the display image. In one example, the layout decision unit 334, in the case where a captured image is received from the image capturing apparatus 100, can identify a plurality of cropping positions from the captured image and can specify a cropping position corresponding to the configuration image from the identified plurality of cropping positions. In one example, the layout decision unit 334, in the case where a captured image is received from the respective image capturing apparatuses 100, can select a configuration image from the received plurality of captured images. In one example, in the case where the captured images are received from a plurality of image capturing apparatuses 100, the layout decision unit 334 can decide on the cropping position from the captured image selected from the plurality of captured images to set an image corresponding to the cropping position to be the configuration image. The layout information generated by the layout decision unit 334 can include information indicative of the cropping position.

The cropping unit 335 executes processing of cropping a predetermined region from the captured image obtained by capturing with the image capturing apparatus 100. The cropping unit 335 executes the processing of cropping an image of a predetermined region from the captured image on the basis of the layout information received from the layout decision unit 334. The cropping unit 335 crops an image of a predetermined region from the captured image to generate a cropped image. The cropping unit 335 outputs the cropped image to the display image generation unit 336.

FIG. 6 is a diagram illustrated to describe cropping processing by the cropping unit 335. The cropping unit 335 executes the cropping processing on an image of a region R from the captured image IM1 on the basis of the layout information received from the layout decision unit 334, as illustrated in FIG. 6. The cropping unit 335 crops an image of the region R from the captured image IM1 to generate a cropped image 50. The cropping unit 335 outputs the generated cropped image 50 to the display image generation unit 336.

The display image generation unit 336 synthesizes the materials received from the input apparatus 200 and the image received from the cropping unit 335 to generate a display image. The display image generation unit 336 generates the display image on the basis of the layout information received from the layout decision unit 334. The display image generation unit 336, when generating the display image, can perform magnification, reduction, or other processing on at least a part of the cropped image and the materials to generate the display image. The display image generation unit 336, when generating the display image, can add effects to the display image. In one example, the display image generation unit 336 can add effects such as moving the materials, applying effects to the materials, or fading out the materials, to the generated display image. The display image generation unit 336 can output, as the display image, the materials, the cropped images, and the like as they are or in the processed form.

[1-3. Decision of Layout]

The description is now given on how to decide on the layout of the display image depending on the scene of a seminar. Examples of the scene of a seminar include “question-and-answer scene”, “walking scene”, “material changeover scene”, “board writing scene”, and “commentary scene”. The scene information indicative of the scene is the main-subject action information indicative of the action of the main subject 10. The main-subject action information includes various types of scene information. The information indicating scenes such as “question-and-answer scene”, “walking scene”, “material changeover scene”, “board writing scene”, and “commentary scene” is an example of the scene information according to the present disclosure. The main-subject action information includes presenting-object-related action information indicating the action performed by the main subject 10 in relation to the presenting object 20 presented at a seminar. Herein, the presenting-object-related action information includes information indicating a scene such as “material changeover scene”, “board writing scene”, and “commentary scene” among various scenes. In other words, the presenting-object-related action information is not limited to a particular type as long as the main subject 10 is scene information relating to the action using the presenting object 20. The scene information includes information indicative of the posture direction of the main subject 10 or the secondary subject 30.

(1-3-1. Question-and-Answer Scene)

The “question-and-answer scene” refers to a scene where a question-and-answer session is conducted between a lecturer and participants. In other words, the scene information corresponding to the “question-and-answer scene” is the information indicating the question and answer. Examples of the layout of the display image of the “question-and-answer scene” include “single arrangement of bird's-eye view image including lecturer” that is the who image including the lecturer who is the main subject 10 and “single arrangement of bird's-eye view image of participant” that is the whole image including the participants who is the secondary subject 30. In addition, examples of the layout of the display image of the “question-and-answer scene” include “single arrangement of participant's close-up image”, “parallel arrangement of participant's close-up image and lecturer's image”, and “superimposition arrangement of participant's close-up image and lecturer's image”. In other words, the configuration image of the display image of the “question-and-answer scene” includes an image in which the participant who is the secondary subject 30 is used as the subject.

The “single arrangement of bird's-eye view image including lecturer” is a layout in which only the bird's-eye view image including a lecturer is used as the configuration image. The “single arrangement of bird's-eye view image of participant” refers to the bird's-eye view image including at least a participant. The “single arrangement of participant's close-up image” refers to the single arrangement of the close-up image of a participant. The “parallel arrangement of participant's close-up image and lecturer's image” refers to the image layout in which the participant's close-up image and the lecturer's image are displayed in a parallel arrangement. The “superimposition arrangement of participant's close-up image and lecturer's image” refers to the image layout in which the participant's close-up image and the lecturer's image are displayed in the superimposed arrangement.

In the case where the seminar scene is determined to be the “question-and-answer scene”, the layout decision unit 334 decides on, as a layout of the display image, any one of the layouts of “single arrangement of bird's-eye view image including lecturer”, “single arrangement of bird's-eye view image of participant”, “single arrangement of participant's close-up image”, “parallel arrangement of participant's close-up image and lecturer's image”, and “superimposition arrangement of participant's close-up image and lecturer's image”. In this case, the layout decision unit 334 decides on the “single arrangement of bird's-eye view image including lecturer” as the main layout. Then, the layout decision unit 334 can change the layout to one of the layouts of “single arrangement of bird's-eye view image of participant”, “single arrangement of participant's close-up image”, “parallel arrangement of participant's close-up image and lecturer's image”, or “superimposition arrangement of participant's close-up image and lecturer's image”, depending on the situation.

(1-3-2. Walking Scene)

The “walking scene” refers to a scene in which a lecturer is walking during a lecture at a seminar. In other words, the scene information indicative of the “walking scene” is information relating to the walking of a lecturer who is the main subject 10. Examples of the layout of the display image of the “walking scene” include “single arrangement of lecturer's tracking cropped image”, “single arrangement of bird's-eye view image of lecturer”, and “single arrangement of bird's-eve view image including lecturer”. The “single arrangement of the lecturer's tracking cropped image” refers to the image layout of tracking the lecturer in close-up. In other words, the configuration image of the display image of the “walking scene” includes an image in which the lecturer, who is the main subject 10, is used as the subject.

In the case where the seminar scene is determined to be the “walking scene”, the layout decision unit 334 decides on, as a layout of the display image, the layout of the “single arrangement of lecturer's tracking cropped image”, the “single arrangement of bird's-eye view image of lecturer”, or the “single arrangement of bird's-eye view image including lecturer”. In this case, the layout decision unit 334 decides on, as the main layout, the “lecturer's tracking cropped image”. The layout decision unit 334 then can change the layout to one of the layouts of the “single arrangement of bird's-eye view image of lecturer” or the “single arrangement of bird's-eye view image including lecturer”, depending on the situation.

(1-3-3. Material Changeover Scene)

The “material changeover scene” refers to a scene in which the materials, which are the presenting object 20 presented to participants in the seminar lecture by a lecturer, are changed. In other words, the scene information indicating the “material changeover scene” is the information indicating the changeover of materials by the main subject 10, which is included in the presenting-object-related action information. Herein, the “material changeover scene” also includes a scene performing slide feeding, which is a material to be presented. An example of the layout of the display image of the “material changeover scene” includes “single arrangement of presenting object image”. In particular, the presenting object image is an image of the materials being presented.

The “single arrangement of presenting object image” refers to a layout of displaying the presenting object image on the entire surface of a display screen. The layout decision unit 334, in the case where the seminar scene is determined to be the “material changeover scene”, decides on the “single arrangement of presenting object image” as the layout of the display image.

(1-3-4. Board Writing Scene)

The “board writing scene” refers to a scene where a lecturer is writing on a target to be written such as a blackboard or whiteboard at a seminar. In other words, the scene information indicating the “board writing scene” is the information indicating the board writing by the main subject 10, which is included in the presenting-object-related action in Examples of the layout of the display image of the “board writing scene” include “parallel arrangement of writing image and lecturer's image”, “superimposition arrangement of writing image and lecturer's image”, and “single arrangement of writing image”. Examples of the “superimposition arrangement of writing image and lecturer image” include “picture-in-picture arrangement of writing image and lecturer's image”, “extraction arrangement of lecturer's image and writing image with extracted lecturer image superimposition writing image”, and “transparent arrangement of transparent lecturer superimposition writing image”. In other words, the writing image is included in the configuration image of the display image of the “board writing scene”. The writing image can be an image indicating a board-writing extraction result.

The “parallel arrangement of writing image and lecturer's image” refers to the layout of the image in which the writing image and the lecturer's image are displayed in a parallel arrangement. The “superimposition arrangement of writing image and lecturer's image” refers to the image layout of displaying the writing image and the lecturer's image in the superimposed arrangement. The “single arrangement of writing image” refers to the layout of displaying a single writing image on the entire surface of the display screen. The “extraction arrangement of lecturer's image and writing image with extracted lecturer image superimposition writing image” refers to the layout of the image in which the lecturer is superimposed on the writing image. The “transparent arrangement of transparent lecturer superimposition writing image” refers to the layout of the image in which the lecturer is transparent and superimposed.

In the case of determining that the seminar scene is the “board writing scene”, the layout decision unit 334 decides on, as the layout of the display screen, one of the layouts of “side-by-side arrangement of writing image and lecturer's image”, “picture-in-picture arrangement of writing image and lecturer's image”, “single arrangement of writing image”, “extraction arrangement of lecturer's image and writing image with extracted lecturer image superimposition writing image”, and “transparent arrangement of transparent lecturer superimposition board-writing extraction result”. In this case, the layout decision unit 334 decides on the “transparent arrangement of transparent lecturer superimposition writing image” as the main layout. Then, the layout decision unit 334 can change the layout to one of the layouts of “side-by-side arrangement of writing image and lecturer's image”, “picture-in-picture arrangement of writing image and lecturer's image”, “single arrangement of writing image”, and “extraction arrangement of lecturer's image and writing image with extracted lecturer image superimposition writing image”, depending on the situation.

(1-3-5. Commentary Scene)

The “commentary scene” refers to a scene where a lecturer is giving a commentary regarding the presenting object 20 of a seminar. In other words, the scene information indicating the “commentary scene” is information indicating the commentary on the presenting object 20 by the main subject 10, which is included in the presenting-object-related action information. Examples of the layout of the display image of the “commentary scene” include “parallel arrangement of writing image and lecturer's image”, “superimposition arrangement of writing image and lecturer's image”, and “single arrangement of writing image”. Examples of the “superimposition arrangement of writing image and lecturer image” include “picture-in-picture arrangement of writing image and lecturer's image”, “extraction arrangement of lecturer's image and writing image with extracted lecturer image superimposition writing image”, and “transparent arrangement of transparent lecturer superimposition writing image”. An example of the “single arrangement of writing image” includes “single arrangement of writing image” in which the lecturing material or the writing image on a board is displayed on the entire screen. In other words, the configuration image of the display image of the “commentary scene” includes a presenting object image, that is, an image indicating materials or the board-writing extraction result.

The layout decision unit 334, in the case where the seminar scene is the “commentary scene”, decides on, as the layout of the display image, one of “side-by-side arrangement of writing image and lecturer's image”, “picture-in-picture arrangement of writing image and lecturer's image”, “single arrangement of writing image”, “extraction arrangement of lecturer superimposition writing image”, and “transparent arrangement of transparent lecturer superimposition writing image”. In this case, the layout decision unit 334 decides on the “side-by-side arrangement of writing image and lecturer's image” as the main layout. Then, the layout decision unit 334 can change from the decided main layout to one of the layouts of the “picture-in-picture arrangement of writing image and lecturer's image”, the “single arrangement of writing image”, the “extraction arrangement of lecturer's image and writing image with extracted lecturer image superimposition writing image”, and the “transparent arrangement of transparent lecturer superimposition board-writing extraction result”, depending on the situation.

The layout decision unit 334 can decide on the layout using, for example, the facial-expression estimation data obtained by the posture estimation unit 331. In one example, the layout decision unit 334 can decide on the layout of displaying a lecturer in close-up in the case of recognizing the rise of the lecturer's emotional or physical tension by the facial-expression estimation data. In one example, the layout decision unit 334 can decide on the layout of displaying the lecturer's bird's-eye view or displaying lecturing materials on the entire screen in the case of recognizing that the lecturer is feeling down by the facial-expression estimation data. In one example, the layout decision unit 334, in the case of recognizing that a seminar participant concentrates on the seminar, can decide on the layout of displaying a bird's-eye view image of participants including the participant concentrating. In one example, in the case of recognizing that the seminar participants are being surprised, the layout decision unit 334 can decide on the layout of displaying the participant surprised in close-up.

[1-4. Layout of Display Image]

The description is now given of the layout of the display image according to the present disclosure. The display image layout herein includes a parallel arrangement, a superimposition arrangement, and a writing-image single arrangement. The parallel arrangement includes a side-by-side arrangement. The superimposition arrangement includes a picture-in-picture arrangement, an extraction arrangement, and a transparent arrangement. The writing-image single arrangement is described.

(1-4-1. Side-by-Side Arrangement)

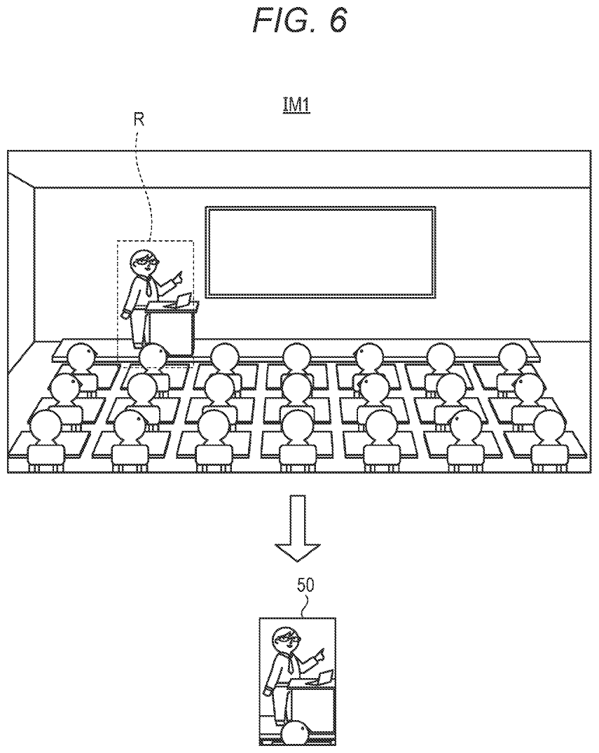

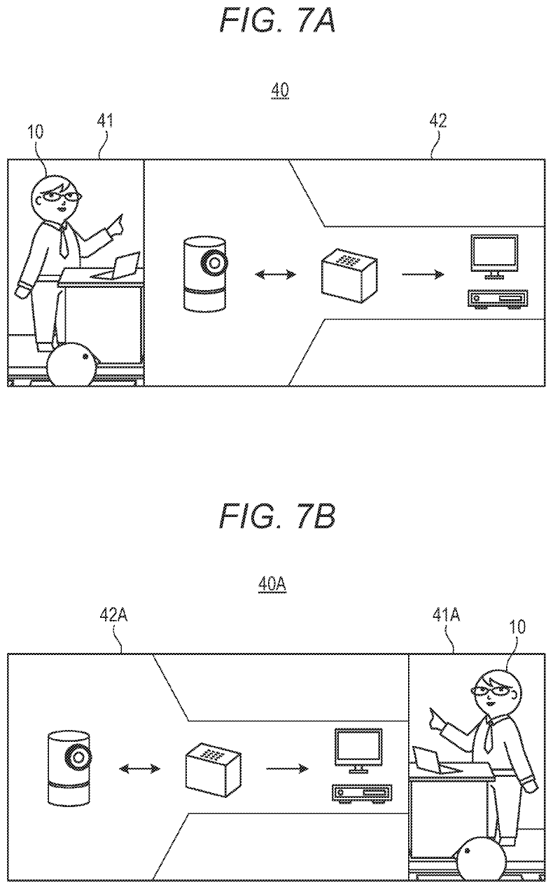

The side-by-side arrangement is a layout in which two configuration images are arranged side by side. FIGS. 7A and 7B illustrate display images of the side-by-side arrangement.

FIG. 7A is a diagram illustrated to describe a first example of the side-by-side arrangement. A display image 40 includes a first image display region 41 and a second image display region 42. The image of the main subject 10 is displayed in the first image display region 41.

FIG. 7B is a diagram illustrated to describe a second example of the side-by-side arrangement. A display image 40A includes a first image display region 41A and a second image display region 42A. The image of the main subject 10 is displayed in the first image display region 41A.

(1-4-2. Picture-in-Picture Arrangement)

The picture-in-picture arrangement is a way in which a plurality of images is arranged in a superimposed manner. Specifically, the picture-in-picture arrangement is, for example, an arrangement in which a second image is superimposed on a partial region of a first image displayed on the entire display screen. In this case, a position where the second image is superimposed is not limited to a particular place. In one example, the second image can be superimposed on the central region of the first image or on one of the four corners of the first image. In addition, a plurality of images such as a third image, a fourth image, or the like can be superimposed on the first image. The description is now given of an example in which the second image is arranged at one of the four corners of the first image as an example of the picture-in-picture arrangement.

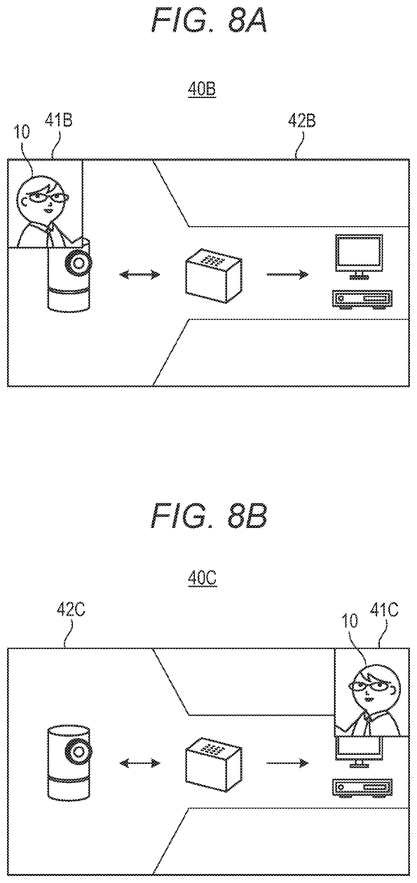

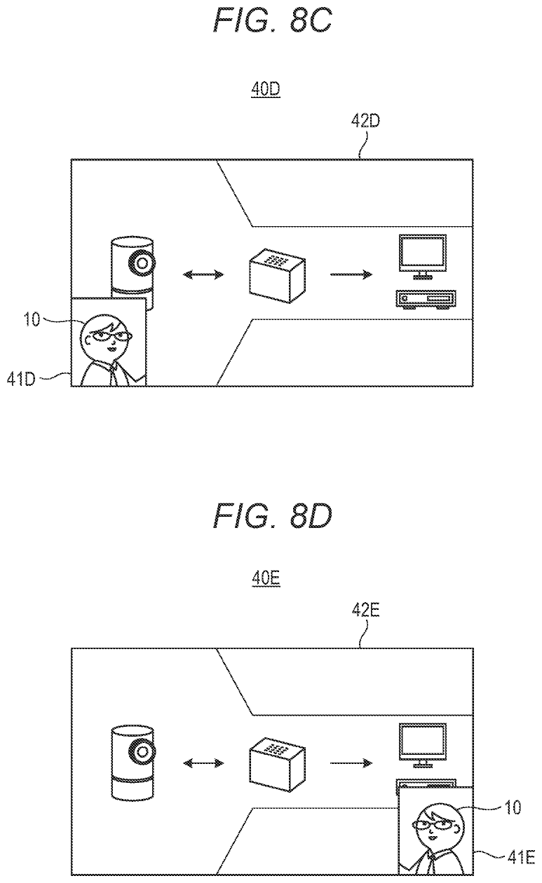

FIGS. 8A, 8B, 8C, and 8D illustrate display images of the picture-in-picture arrangement.

FIG. 8A is a diagram illustrated to describe a first example of the display image in a picture-in-picture arrangement. A display image 40B includes a first image display region 41B and a second image display region 42B. The image of the main subject 10 is displayed in the first image display region 41B. In the second image display region 42, materials and the like projected on the screen at the seminar are displayed. In other words, the layout decision unit 334 can decide on the layout of the picture-in-picture arrangement in which the video of the materials is displayed on the entire display screen, and the main subject 10 is displayed in the upper left corner.

FIG. 8B is a diagram illustrated to describe a second example of the display image in a picture-in-picture arrangement. A display image 40C includes a first image display region 41C and a second image display region 42C. The image of the main subject 10 is displayed in the first image display region 41C. In the second image display region 42C, materials and the like projected on the screen at the seminar are displayed. In other words, the layout decision unit 334 can decide on the layout of the picture-in-picture arrangement in which the video of the materials is displayed on the entire display screen, and the main subject 10 is displayed in the upper right corner.

FIG. 8C is a diagram illustrated to describe a third example of the display image in a picture-in-picture arrangement. A display image 40D includes a first image display region 41C and a second image display region 42D. The image of the main subject 10 is displayed in the first image display region 41D. In the second image display region 42D, materials and the like projected on the screen at the seminar are displayed. In other words, the layout decision unit 334 can decide on the layout of the picture-in-picture arrangement in which the video of the materials is displayed on the entire display screen, and the main subject 10 is displayed in the lower left corner.

FIG. 8D is a diagram illustrated to describe a fourth example of the display image in a picture-in-picture arrangement. A display image 40E includes a first image display region 41E and a second image display region 42E. The image of the main subject 10 is displayed in the first image display region 41E. In the second image display region 42E, materials and the like projected on the screen at the seminar are displayed. In other words, the layout decision unit 334 can decide on the layout of the picture-in-picture arrangement in which the video of the materials is displayed on the entire display screen, and the main subject 10 is displayed in the lower right corner.

In the case of deciding on the layout of the picture-in-picture arrangement, the layout decision unit 334 can display the image of the main subject 10 in the portion where no characters, figures, and the like are shown in the materials displayed on the entire display screen.

(1-4-3. Extraction Arrangement)

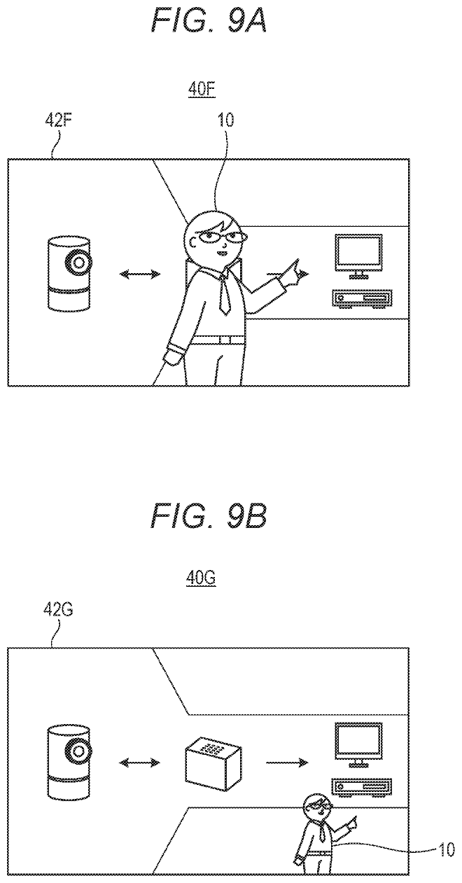

The layout decision unit 334 can decide on, as the layout of the display image, the layout of the extraction arrangement in which the image of the main subject 10 is extracted and is superimposed on the presenting object 20. FIGS. 9A and 9B illustrate display images of the transparent arrangement.

FIG. 9A is a diagram illustrated to describe a first example of the display image in an extraction arrangement. A display image 40F includes a second image display region 42F. The display image 40F does not include a region in which the main subject 10 is displayed. In the display image 40F, the main subject 10 is displayed. In a superimposed manner on the second image display region 42F. In this case, the main subject 10 is only required to be extracted using the person extraction processing in the related art on the basis of the captured image and is only required to be superimposed on the second image display region 42F.

FIG. 9B is a diagram illustrated to describe a second example of the display image in an extraction arrangement. A display image 40G includes a second image display region 42G. In the display image 40G, the main subject 10 is displayed in a superimposed manner on the second image display region 42G in a reduced form. This configuration prevents characters or the like on the second image display region 42G from being hidden by the superimposed main subject 10, making it easier to visually recognize the display image 40G.

(1-4-4. Transparent Arrangement)

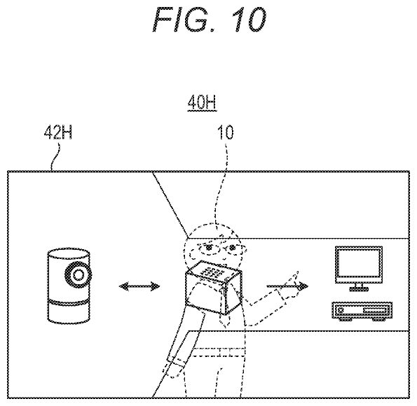

The layout decision unit 334 can decide on, as the layout of the display image, the transparent layout in which the image of the main subject 10 is superimposed on the materials in such a way that the image of the main subject 10 is transmitted through the material. FIG. 10 illustrates a display image of the transparent arrangement.

FIG. 10 is a diagram illustrated to describe an example of the transparent arrangement. A display image 40H, a display image 40H includes a second image display region 42H. In the display image 40G, the main subject 10 is displayed in a superimposed manner on the second image display region 42H in a transparent state. This configuration prevents characters or the like on the second image display region 42H from being hidden by the superimposed main subject 10, making it easier to visually recognize the display image 40H.

(1-4-5. Single Arrangement)

The layout decision unit 334 can decide on, as the layout of the display image, the layout in which one configuration image is displayed as a single entity on the entire display image. In one example, the presenting object image is displayed as a single entity on the entire display screen. In this case, the presenting object 20 can be displayed on the entire screen, while the main subject 10 is riot displayed in the display image. In addition, for example, the person image including the main subject 10 or the secondary subject 30 as the subject can be displayed as a single entity on the entire display screen. In this case, the single arrangement including only the image of the main subject 10 or the single arrangement including only the image of the secondary subject 30 can be used. In addition, a single arrangement including only the main subject 10 and the secondary subject 30 can be used.

[1-5. Processing by Information Processing Apparatus]

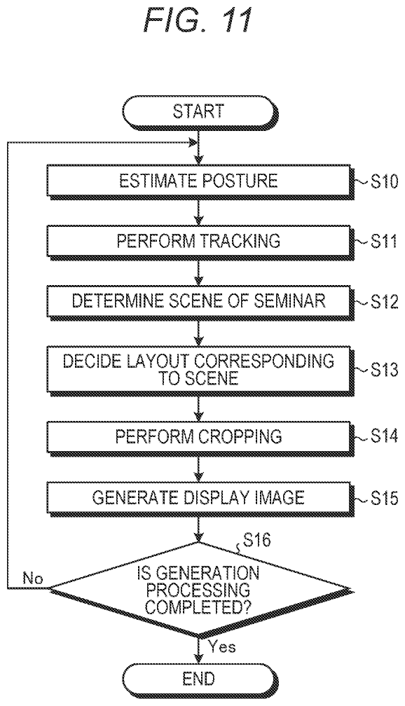

The description is given of the procedure of the processing by an information processing apparatus according to the first embodiment with reference to FIG. 11. FIG. 11 is a flowchart illustrating an example of the procedure of the processing by the information processing apparatus according to the first embodiment.

The flowchart in FIG. 11 illustrates the procedure of the processing of determining the scene of the seminar in which the lecturer, who is the main subject 10, is giving a lecture using the materials projected on the screen by a projector or the like and generating a display image depending on the scene.

The control unit 330 estimates the posture of a lecturer (step S10). Specifically, the posture estimation unit 331 estimates the lecturer's posture on the basis of the captured image obtained by capturing with the image capturing apparatus 100.

The control unit 330 performs tracking processing (step S11). Specifically, the tracking unit 332 tracks the lecturer across frames of the captured image on the basis of the captured image obtained by capturing with the image capturing apparatus 100 and a result obtained by estimating the posture of the lecturer.

The control unit 330 determines a scene of a seminar (step S12). Specifically, the action recognition unit 333 determines a scene on the basis of the captured image obtained by capturing with the image capturing apparatus 100.

The control unit 330 determines the layout corresponding to the seminar scene (step S13). Specifically, the layout decision unit 334 decides on the layout of the display image to be displayed on the display screen on the basis of a result obtained by determining the scene in the action recognition unit 333.

The control unit 330 performs cropping processing on the captured image (step S14). Specifically, the cropping unit 335 executes cropping processing on the captured image on the basis of the layout decided by the layout decision unit 334 to generate a cropped image.

The control unit 330 generates a display image to be displayed on the display apparatus 400 (step S15). Specifically, the display image generation unit 336 generates a display image depending on the layout decided by the layout decision unit 334C using the cropped image.

The control unit 330 determines whether or not display image generation processing is completed (step S16). Specifically, the control unit 330 determines that the display image generation processing is completed upon ending the seminar or upon receiving an instruction from a user to complete the generation processing. If the determination is affirmative (Yes) at step S16, the processing of FIG. 6 ends. On the other hand, if the determination is negative (No) at step S16, the processing proceeds to step S10, and the processing of steps S10 to S15 is repeated.

As described above, in the first embodiment, the determination of the seminar scene is performed, and the decision of the display image layout is performed depending on the scene determination result. This configuration in the first embodiment makes it possible to generate an appropriate display image depending on the seminar scene.

Moreover, in the embodiment described above, only the information processing apparatus 300 performs the entire processing for generating the display image to be displayed on the display apparatus 400, but this configuration is illustrative, and the present disclosure is not limited to such a configuration. The information processing apparatus 300 cart have a configuration to include any one of the posture estimation unit 331, the tracking unit 332, the action recognition unit 333, and the layout decision unit 334. In other words, herein, the posture estimation unit 331, the tracking unit 332, the action recognition unit 333, and the layout decision unit 334 can be provided in a distributed manner among a plurality of apparatuses. In other words, in the present disclosure, the processing of generating the display image to be displayed on the display apparatus 400 can be performed among a plurality of different apparatuses.

### 2. Second Embodiment

The description is now given of a second embodiment. The premise is based on changing lecture situations in which a lecturer gives a lecture using materials projected on the screen. In one example, the premise is based on a situation where the lecturer's posture is facing right as viewed by the audience and a situation where the lecturer is facing left, in the case where the lecturer gives a commentary using the materials projected on the screen. Thus, in the second embodiment, the layout is changed to a display arrangement appropriate depending on the posture direction of the lecturer.

[2-1. Configuration of Information Processing Apparatus]

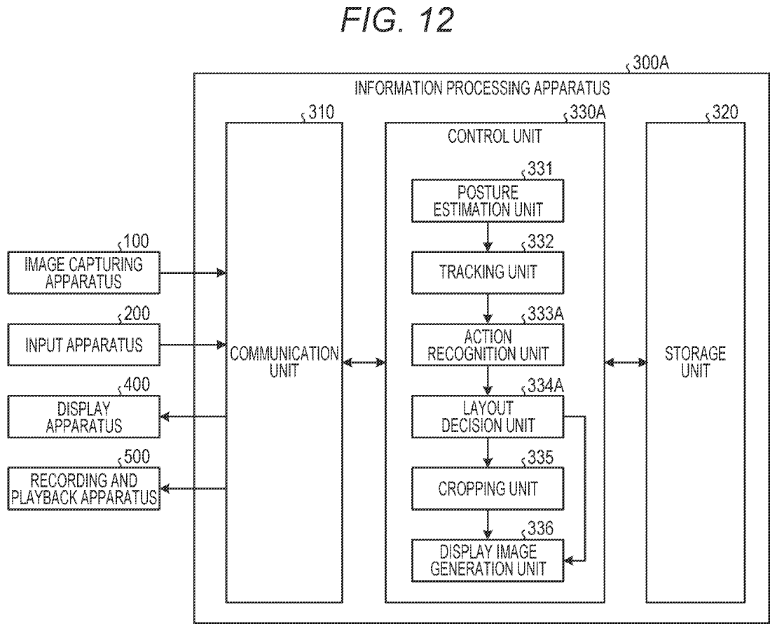

The description is given of the configuration of an information processing apparatus according to the second embodiment with reference to FIG. 12. FIG. 12 is a block diagram illustrating a configuration of the information processing apparatus according to a second embodiment.

As illustrated in FIG. 12, an information processing apparatus 300A differs in the processing executed by an action recognition unit 333A and a layout decision unit 334A of a control unit 330A from the information processing apparatus 300 illustrated in FIG. 2.

The action recognition unit 333A specifies the posture direction of the main subject 10 or the secondary subject 30. The posture direction refers to the direction in which the person is facing. The action recognition unit 333A uses the tracking result and the posture estimation information to specify the posture direction of each of the main subject 10 and the secondary subject 30. The tracking result can include the posture estimation information. The action recognition unit 333A can specify the direction in which the main subject 10 and the secondary subject 30 are facing on a rule basis. The rule basis can be obtained by associating, for example, the state of joints and bones of the skeleton used as the posture estimation information and the posture direction in advance. The action recognition unit 333A can specify the posture direction of the main subject 10 and the secondary subject 30 on the basis of the state of joints and bones of the skeleton and the estimation result. The action recognition unit 333A can specify the posture direction for all the persons of the main subject 10 and the secondary subject 30 or the posture direction of only a particular person. The action recognition unit 333A outputs information regarding a result obtained by the recognition to the layout decision unit 334.

The action recognition unit 333A can refer to the data stored in the storage unit 320 and perform learning for specifying the posture direction of the main subject 10 and the secondary subject 30 using a neural network, creating a determination model from a result obtained by the learning. The action recognition unit 333A can specify the direction in which the main subject 10 and the secondary subject 30 are facing by using the created determination model. In other words, the action recognition unit 333A can specify the posture directions of the main subject 10 and the secondary subject 30 by using machine learning. In this case, the action recognition unit 333A can learn the image in which the posture directions of the person have various directions with machine learning without using the tracking result and the posture estimation information. This configuration allows the action recognition unit 333A to specify the posture directions of the main subject 10 and the secondary subject 30 on the basis of the captured image obtained by capturing with the image capturing apparatus 100. In the present embodiment, the action recognition unit 333A specifies, for example, whether the main subject 10 is facing right or left as viewed by the audience.

The layout decision unit 334A decides on the layout of the display image that is to be displayed on the display apparatus 400. The layout decision unit 334A decides on the layout of the display image on the basis of the captured image received from the image capturing apparatus 100, the information relating to the materials (the presenting object 20) received from the input apparatus 200, and the recognition result received from the action recognition unit 333A. The layout decision unit 334A decides on, for example, the configuration image that is an image constituting at least a part of the display image on the basis of the scene information. The layout decision unit 334A decides on the layout of the display image to be displayed on the display apparatus 400, for example, on the basis of the posture direction of the main subject 10. In the case where the display image includes a plurality of configuration images, the layout decision unit 334A decides on the display arrangement of a first configuration image in the display image on the basis of the posture direction of the person in the person image that is the first configuration image being one of the plurality of configuration images. In the case where the person in the person image is facing to the right as viewed by the audience, the person image is arranged in such a way that the center of the display image is placed to the left side relative to the center of the person image. In the case where the display image includes at least the first configuration image and the second configuration image, the layout decision unit 334A decides on the display arrangement in such a way that the posture direction of the person in the person image that is the first configuration image corresponds to the positional relationship of the center of the second configuration image relative to the position of the center of the first configuration image in the display image. Specifically, the layout decision unit 334A decides on the display arrangement in such a way that the posture direction of the person that is the first configuration image faces the center of the second configuration image. Herein, the center of the image can be the center of gravity of the image.

The layout decision unit 334A specifies the cropping position in the captured image for generating the display image. In one example, in the case where the captured image is received from the image capturing apparatus 100, the layout decision unit 334A can specify a plurality of cropping positions from the captured image and select a display image from the specified plurality of cropping positions. In one example, in the case where the captured images are received from a plurality of image capturing apparatuses 100, the layout decision unit 334A can select the display image from the plurality of captured images. The layout decision unit 334 outputs the layout information regarding the decided layout and information regarding the cropping position to the display image generation unit 336 and the cropping unit 335.

The layout decision unit 334A decides on the display arrangement depending on the posture direction of the main subject 10 as viewed by the audience. The layout decision unit 334A decides on the display arrangement to be, for example, either parallel arrangement or superimposition arrangement. The parallel arrangement includes a side-by-side arrangement. The superimposition arrangement includes the picture-in-picture arrangement, the extraction arrangement, and the transparent arrangement. In the present disclosure, for example, in the case where the layout of the display image is determined to be the side-by-side arrangement, the layout decision unit 334A changes the layout of the side-by-side arrangement depending on the posture direction of the main subject 10 as viewed by the audience.

In the case where the action recognition unit 333A specifies that the main subject 10 is facing to the right as viewed by the audience, the layout decision unit 334A decides on, as the layout of the display image, the layout of the side-by-side arrangement illustrated in FIG. 7A. FIG. 7A illustrates the display image 40 of the case where the main subject 10 is facing to the right as viewed by the audience. A display image 40 includes a first image display region 41 and a second image display region 42. The image of the main subject 10 is displayed in the first image display region 41. In the second image display region 42, materials and the like projected on the screen at the seminar are displayed. In the case where the main subject 10 is facing to the right, the layout decision unit 334 decides on the layout in which the main subject 10 is displayed on the left side and the materials are displayed on the right side.

In the case where the action recognition unit 333A specifies that the main subject 10 is facing to the left as viewed by the audience, the layout decision unit 334A is a diagram to explain the layout of the display image, the layout of the side-by-side arrangement illustrated in FIG. 7B. FIG. 7B illustrates the display image 40A of the case where the main subject 10 is facing to the left as viewed by the audience. A display image 40A includes a first image display region 41A and a second image display region 42A. In the first image display region 41A, the image of the main subject 10 is displayed, in the second image display region 42A, materials and the like projected on the screen at the seminar are displayed. In the case where the main subject 10 is facing to the left as viewed by the audience, the layout decision unit 334 decides on the layout in which the materials is displayed on the left side and the main subject 10 are displayed on the right side.

In other words, the layout decision unit 334 decides on the layout of the side-by-side arrangement in which the images of the main subject 10 and the material are arranged adjacent to each other. As illustrated in FIG. 7A or 7B, the side-by-side arrangement of the display images allows the video of the materials to be positioned in the orientation of the main subject 10, making it easier for the user to visually recognize the display image 40 or the display image 40A.

If the layout of the display image is changed each time the orientation of the main subject 10 varies, the visual recognition of the display image is liable to be difficult for the user, so the layout decision unit 334 can execute the processing, for example, for stabilizing the layout of the display image. In one example, the layout decision unit 334 can change the layout in the case where the main subject 10 faces the same direction for a predetermined time or longer (e.g., five seconds or longer).

If the layout of the display image is changed due o erroneous detection or the like by the layout decision unit 334A and the action recognition unit 333A, the visual recognition of the display image is liable to be difficult for the user, so the processing can be executed, for example, for stabilizing the layout of the display image. In one example, the layout decision unit 334A can change the layout in the case where the main subject 10 faces the same direction for a predetermined time or longer (e.g., ten seconds or longer).

[2-2. Processing by Information Processing Apparatus]

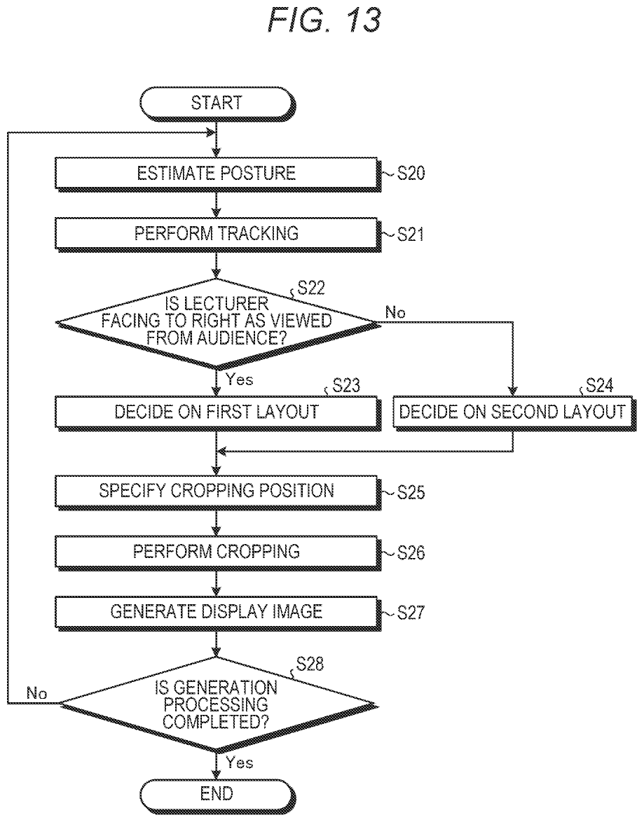

The description is given of the procedure of the processing by the information processing apparatus according to the second embodiment with reference to FIG. 13. FIG. 13 is a flowchart illustrating an exemplary processing procedure of the information processing apparatus according to the second embodiment.

The flowchart in FIG. 13 illustrates the processing procedure for generating a display image of the circumstance in which a lecturer, who is the main subject 10, is giving a lecture using materials projected on a screen by a projector or other equipment at a seminar or the like. Moreover, the flowchart illustrated in FIG. 13 can be similarly applied even in the, case where the lecturer gives a commentary while writing on the board.

The control unit 330A estimates the posture of a lecturer (step S20). Specifically, the posture estimation unit 331 estimates the lecturer's posture on fie basis of the captured image obtained by capturing with the image capturing apparatus 100.

The control unit 330A performs tracking processing (step S21). Specifically, the tracking unit 332 tracks the lecturer across frames of the captured image on the basis of the captured image obtained by capturing with the image capturing apparatus 100 and a result obtained by estimating the posture of the lecturer.

The control unit 330A determines whether or not the lecturer is facing to the right as viewed from the audience (step S22). Specifically, the processing proceeds to step S23 if the action recognition unit 333A determines that the lecturer is facing to the right as viewed from the audience (Yes at step S22) on the basis of the estimation result of the lecturer's posture. On the other hand, it is determined that the lecturer is not facing to the right as viewed from the audience (No at step S22), the processing proceeds to step S24.

If the determination result is affirmative (Yes) at step S22, the control unit 330A decides on the layout of the display image as the first layout (step S23). Specifically, the layout decision unit 334A decides on, as the layout of the display image, the layout in which the lecturer is displayed on the left side and the materials are displayed on the right side.

If the determination result is negative (No) at step S22, the control unit 330A decides on the layout of the display image as the second layout (step S24). Specifically, the layout decision unit 334A decides on, as the layout of the display image, the layout in which the materials are displayed on the left side and the lecturer is displayed on the right side.

The control unit 330A specifies the cropping position in the captured image (step S25). Specifically, the layout decision unit 334A specifies the cropping position for generating a cropped image for use in the display image.

The control unit 330A performs cropping processing on the captured image (step S26). Specifically, the cropping unit 335 executes cropping processing on the captured image on the basis of the result of the cropping position specified by the layout decision unit 334A to generate a cropped image.

The control unit 330 generates a display image to be displayed on the display apparatus 400 (step S27). Specifically, the display image generation unit 336 makes the cropped image and the image of the materials to generate a display image depending on the layout decided by the layout decision unit 334A.

The control unit 330A determines whether or not display image generation processing is completed (step S28). Specifically, the control unit 330A determines that the display image generation processing is completed upon ending the seminar or upon receiving an instruction from a user to complete the generation processing. If the determination is affirmative (Yes) at step S28, the processing of FIG. 9 ends. On the other hand, if the determination is negative (No) at step S28, the processing proceeds to step S20, and the processing of steps S20 to S27 is repeated.

As described above, in the first embodiment, the layout can be changed to the side-by-side arrangement in which the lecturer and the materials are displayed side by side depending on the orientation of the lecturer who gives a lecture using the material. According to the first embodiment, this configuration makes it possible to provide a display screen that does not give the feeling of incompatibility even if the orientation of the lecturer varies.

### 3. Third Embodiment

The description is now given of a third embodiment. The premise is based on changing lecture situations in which a lecturer gives a lecture using materials projected on the screen. In one example, in a situation where the lecturer is giving a commentary while walking, the premise is given that the commentary is given without using materials. In such a case, even if materials are included in the display image, sometimes, the lecturer gives a commentary that is not related to the material. Thus, in the second embodiment, if it is determined that the lecturer is giving a commentary while walking, the layout in which the display image is changed to an appropriate layout that does not include the materials is used.

[3-1. Configuration of Information Processing Apparatus]

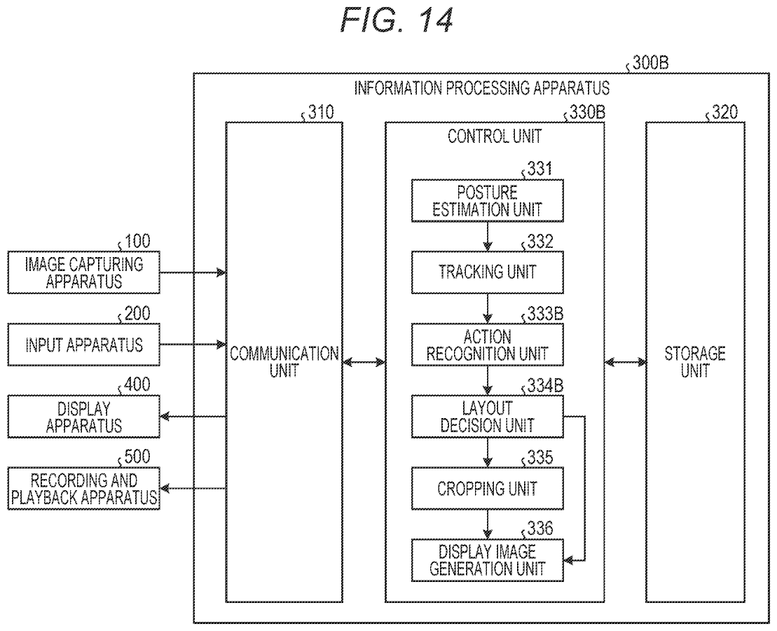

The description is given of the configuration of an information processing apparatus according to the third embodiment with reference to FIG. 14. FIG. 14 is a block diagram illustrating a configuration of the information processing apparatus according to a third embodiment.

As illustrated in FIG. 14, an information processing apparatus 300B differs is the processing executed by an action recognition unit 333B and a layout decision unit 334B of a control unit 330B from the information processing apparatus 300 illustrated in FIG. 2.

The action recognition unit 333B determines whether or not each of the main subject 10 and the secondary subject 30 is walking. The action recognition unit 333B uses the tracking result to determine whether or not each of the main subject 10 and the secondary subject 30 is walking. The action recognition unit 333B, for example, calculates the motion vector of each of the main subject 10 and the secondary subject 30 using the tracking result and if the calculated motion vector is determined to be the walking speed, the person is determined to be walking. The motion vector determined to be the walking speed can be stored as a piece of information in the storage unit 320 in advance. The action recognition unit 333B can determine whether or not all the persons of the main subject 10 and the secondary subject 30 are walking or can determine whether or not only a particular person is walking. The action recognition unit 333B outputs walking information indicating whether or not the person is walking to the layout decision unit 334B.

The action recognition unit 333B can refer to the data stored in the storage unit 320 and perform learning for determining whether or not the main subject 10 and the secondary subject 30 are walking using a neural network, creating a determination model from a result obtained by the learning. The action recognition unit 333B can specify that the main subject 10 and the secondary subject 30 are walking by using the created determination model. In other words, the action recognition unit 333B can specify that the main subject 10 and the secondary subject 30 are walking by using machine learning. In this case, the action recognition unit 333B can learn the image in which the person is walking with machine learning without using the tracking result and the posture estimation information. This configuration allows the action recognition unit 333B to determine whether or riot the main subject 10 and the secondary subject 30 are walking on the basis of the captured image obtained by capturing with the image capturing apparatus 100.

The layout decision unit 334B decides on the layout of the display image to be displayed on the display apparatus 400. The layout decision unit 334B changes the layout depending on whether or not the main subject 10 is walking. The layout decision unit 334B changes the layout to an appropriate display arrangement depending on whether or not the main subject 10 is walking. If it is determined that the main subject 10 is walking, the layout decision unit 334B decides on, as the layout of the display image, the single arrangement of the noticed image in which the main subject 10 is closed-up.

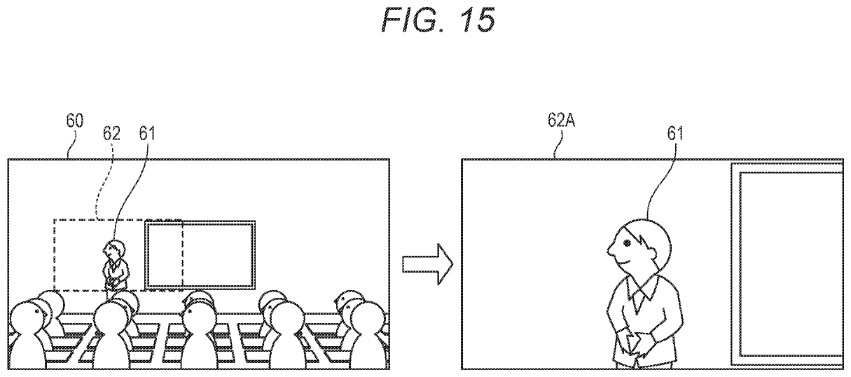

FIG. 15 is a diagram illustrated to describe the layout of a display image in a case of determining that The main subject 10 is walking. FIG. 15 illustrates a display image 60 including a lecturer 61 as the main subject 10. The layout decision unit 334B specifies a region 62 including the lecturer 61, in The case where the action recognition unit 333B determines that the lecturer 61 is walking. The layout decision unit 334B decides on the layout of the display image for displaying an enlarged image 62A of the region 62 on the display apparatus 400. The layout decision unit 334B outputs information relating to the position of the specified region 62 to the cropping unit 335.

If the layout of the display image is changed due to erroneous detection or the like by the action recognition unit 333B, the visual recognition of the display image is liable to be difficult for the user, so the layout decision unit 334B can execute the processing, for example, for stabilizing the layout of the display image. In one example, the layout decision unit 334B can chance the layout in the case where the lecturer 61 is walking for a predetermined time or longer (e.g., three seconds or longer).

[3-2. Processing by Information Processing Apparatus]

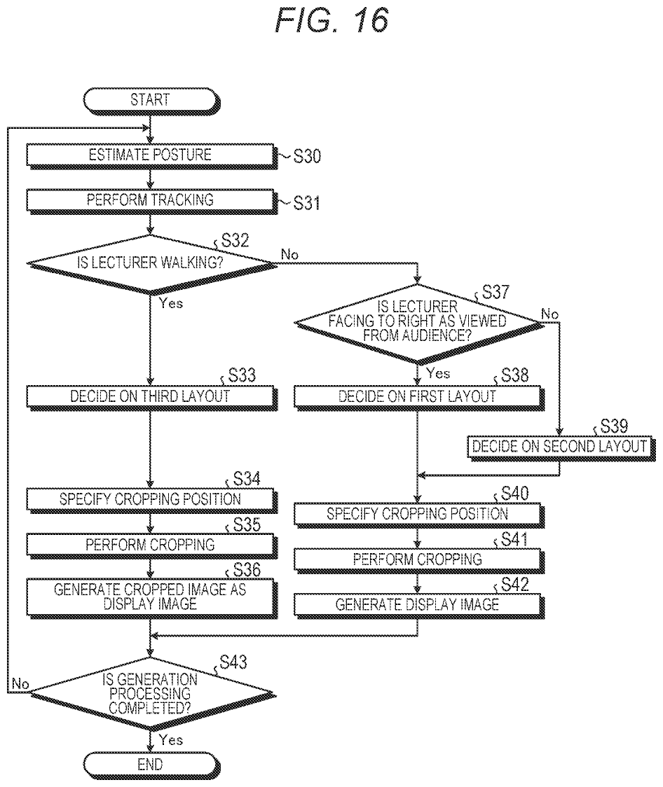

The description is given of the procedure of the processing by an information processing apparatus according to the third embodiment with reference to FIG. 16. FIG. 16 is a flowchart illustrating an exemplary processing procedure of the information processing apparatus according to the third embodiment.

The flowchart in FIG. 16 illustrates the processing procedure for generating a display, image of the circumstance in which a lecturer, who is the main subject 10, is giving a lecture using materials projected on a screen by a projector or other equipment at a seminar or the like. Moreover, the flowchart illustrated in FIG. 16 can be similarly applied even in the case where the lecturer gives a commentary while writing on the board.

Since the processing of steps S30 and S31 is the same as the processing of steps S20 and S21 illustrated in FIG. 13, the description thereof will be omitted.

The control unit 330B determines whether or not the lecturer is walking (step S32). Specifically, the action recognition unit 333B determine whether or not the lecturer is walking by calculating the motion vector of the lecturer on the basis of the posture estimation information. If it is determined that the lecturer is walking (Yes at step S32), the processing proceeds to step S33. On the other hand, if it is not determined that the lecturer is walking (No at step S32), the processing proceeds to step S37.

If the determination result is affirmative (Yes) at step S32, the control unit 330B decides on the layout of the display image as the third layout (step S33) Specifically, the layout decision unit 334B decides on, as the layout of the display image, the layout of the single arrangement of the noticed image with the lecturer 61 closed-up.

The control unit 330B specifies the cropping position in the captured image (step S34). Specifically, the layout decision unit 334B specifies the cropping position for generating a cropped image.

The control unit 330B performs cropping processing on the captured image (step S35). Specifically, the cropping unit 335 executes cropping processing on the captured image on the basis of the result of the cropping position specified by the layout decision unit 334B to generate a cropped image.

The control unit 330B generates a display image to be displayed on the display apparatus 400 (step S36). Specifically, the display image generation unit 336 generates the cropped image as the display image.

The processing of steps S37 to S43 is the same as the processing of steps S22 to S28 illustrated in FIG. 13, so the description thereof is omitted.

As described above, the third embodiment makes it possible to change the layout of the display screen depending on whether or not the lecturer is walking. According to the third embodiment, this configuration makes it possible to provide a display screen that does not give the feeling of incompatibility, even in the scene where the lecturer is giving a commentary while walking without using materials.

### 4. Fourth Embodiment

The description is now given of a fourth embodiment. The premise is given that, for example, a question-and-answer session is conducted in the lecture by a lecturer using materials projected on a screen. In such cases, generating a display image that includes the lecturer, the questioner, and the materials is desirable sometimes. Thus, the fourth embodiment decides on, as the layout of the display image, the single arrangement of the whole image including the instructor and the questioner, in the case where it is determined that the question-and-answer session is being conducted in the lecture.

[4-1. Configuration of Information Processing Apparatus]

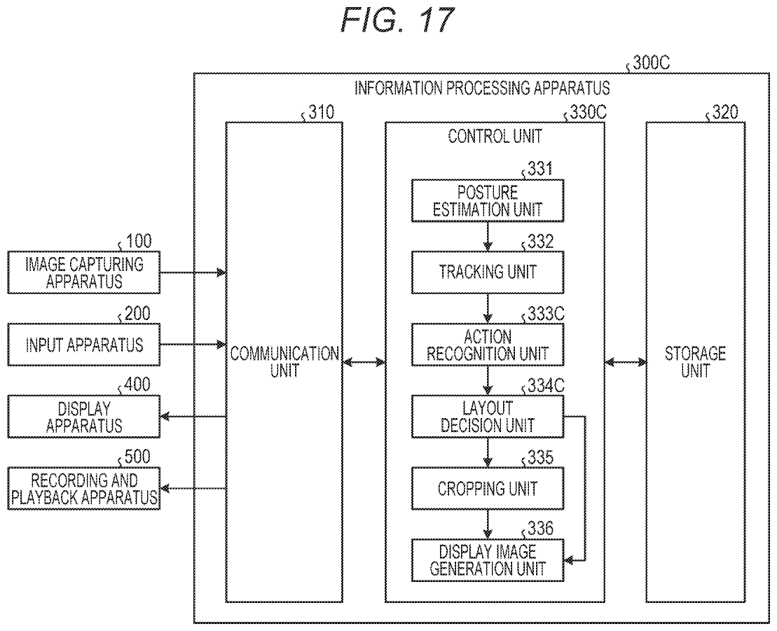

The description is given of the configuration of an information processing apparatus according to the fourth embodiment with reference to FIG. 17. FIG. 17 is a block diagram illustrating a configuration of the information processing apparatus according to the fourth embodiment.

As illustrated in FIG. 17, an information processing apparatus 300C differs in the processing executed by an action recognition unit 333C and a layout decision unit 334C of a control unit 330C from the information processing apparatus 300 illustrated in FIG. 2.

The action recognition unit 333C determines whether or not a question-and-answer session is being conducted in a lecture such as a seminar. The action recognition unit 333C determines whether or not the question-and-answer session is being conducted on the basis of the captured image of the main subject 10 and the secondary subject 30. The action recognition unit 333C determines that the question-and-answer session is being conducted, for example, in the case of detecting the movement of the main subject 10 pointing the secondary subject 30 with its finger or extending its hand toward the secondary subject 30. In one example, in the case of detecting that the main subject 10 nods or shakes its head vertically or horizontally facing the secondary subject 30, the main subject 10 is more likely to be listening to the secondary subject 30. Thus, the act iron recognition unit 333C determines that the question-and-answer session is conducted. The action recognition unit 333C determines that the question-and-answer session is being conducted in the case of detecting the action in which at least one member of the secondary subjects 30 raises the hand or stands up.

The action recognition unit 333C can refer to the data stored in the storage unit 320 and perform the learning to determine whether or not the question-and-answer session is being conducted using a neural network, creating a determination model from a result obtained by the learning. The action recognition unit 333C can determine whether or not the question-and-answer session is conducted by using the created determination model. In other words, the action recognition unit 333C can specify that the question-and-answer session is being conducted by using machine learning. In this case, the action recognition unit 333C can learn the video in which the question-and-answer session is being conducted by machine learning without using the tracking result and the posture estimation information to determine whether or not the question-and-answer session is conducted on the basis of the captured image obtained by capturing with the image capturing apparatus 100.

The layout decision unit 334C decides on the layout of the display image to be displayed on the display apparatus 400. The layout decision unit 334C decides on the layout depending on whether or not the question-and-answer session is being conducted. The layout decision unit 334C changes the layout to an appropriate display arrangement depending on whether or not the question-and-answer session is being conducted. In the case where it is determined that the question-and-answer session is being conducted, the layout decision unit 334C decides on, as the display image to be displayed on the display apparatus 400, only the bird's-eye view image including the main subject 10 and the secondary subject 30 as the configuration image. The bird's-eye view image is sometimes called the whole image.

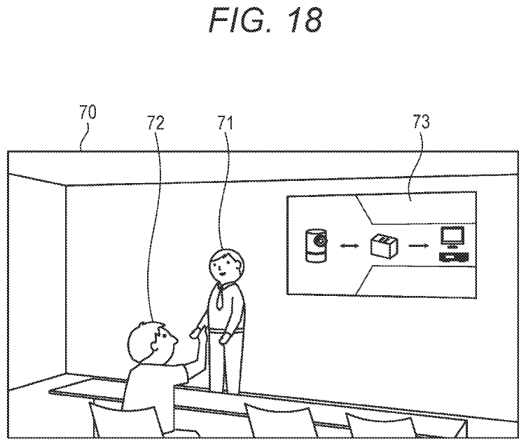

FIG. 18 is a diagram illustrated to describe the layout of a display image in the case of determining that a question-and-answer session holds. FIG. 18 illustrates a display image 70 including a lecturer 71 as the main subject 10 and a participant 72 as the secondary subject 30. In the case where the action recognition unit 333B determines that the question-and-answer session is being conducted, the layout decision unit 335B decides on the display image 70 including only the configuration image including the lecturer 71 and the participant 72 as the layout of the display image.

If the layout of the display image is changed due to erroneous detection or the like by the action recognition unit 333C, the visual recognition of the display image is liable to be difficult for the user, so the layout decision unit 334C can execute the processing, for example, for stabilizing the layout of the display image. In one example, the layout decision unit 334C can chance the layout in the case where it is determined that the lecturer 71 and the participant 72 are talking for a predetermined time or longer (e.g., ten seconds or longer).

[4-2. Processing by Information Processing Apparatus]

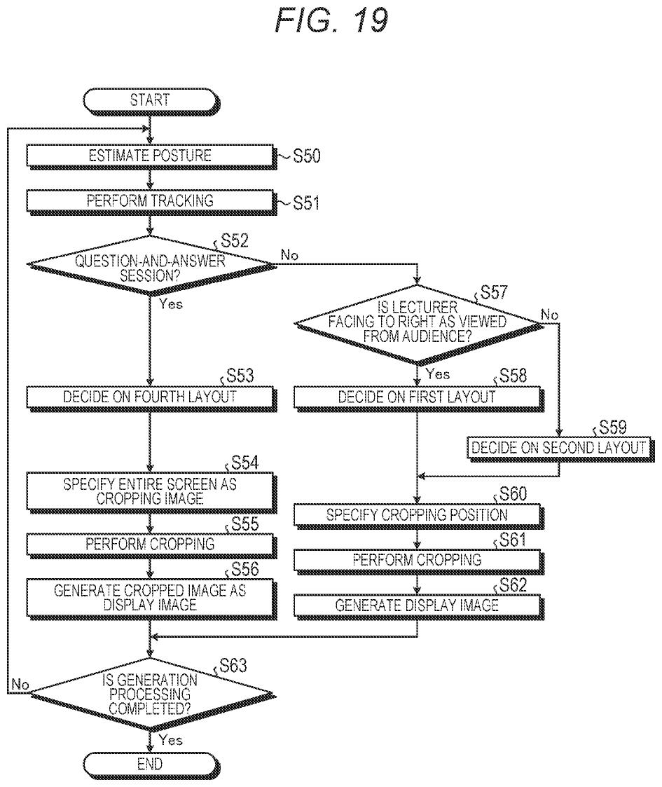

The description is given of the procedure of the processing by an information processing apparatus according to the fourth embodiment with reference to FIG. 19. FIG. 19 is diagram illustrating an exemplary processing procedure of the information processing apparatus according to the fourth embodiment.

The flowchart in FIG. 19 illustrates the processing procedure for generating a display image of the circumstance in which a lecturer, who is the main subject 10, is giving a lecture using materials projected on a screen by a projector or other equipment at a seminar or the like. Moreover, the flowchart illustrated in FIG. 19 can be similarly applied even in the case where the lecturer gives a commentary while writing on the board.

Since the processing of steps S50 and S51 is the same as the processing of steps S20 and S21 illustrated in FIG. 13, the description thereof will be omitted.

The control unit 330B determines whether or not the question-and-answer session is conducted (step S52). Specifically, the action recognition unit 333C determines whether or not the question-and-answer session is being conducted on the basis of the captured images of the lecturer and the participant. If it is determined that the question-and-answer session is conducted (Yes at step S52), the processing proceeds to step S53. If it is not determined that the question-and-answer session is conducted. (No at step S52), the processing proceeds to step S57.

If the determination result is affirmative (Yes) at step S52, the control unit 330C determines the layout of the display image as a fourth layout (step S53). Specifically, the layout decision unit 334C decides on, as the layout of the display image, the layout in which only the bird's-eye view image including the lecturer and the participant is included as the configuration image.

The control unit 330C specifies the entire screen of the captured image as a cropping image (step S54). Specifically, the layout decision unit 334C specifies the whole bird's-eye view image as a cropping position.

The control unit 330C performs cropping processing on the captured image (step S55). Specifically, the cropping unit 335 executes cropping processing on the captured image on the basis of the result of the cropping position specified by the layout decision unit 334C to generate a cropped image.

The control unit 330C generates a display image to be displayed on the display apparatus 400 (step S56). Specifically, the display image generation unit 336 generates a display image using the cropped image as the configuration image.

The processing of steps S57 to S63 is the same as the processing of steps S22 to S28 illustrated in FIG. 13, so the description thereof is omitted,

As described above, the fourth embodiment makes it possible to change the layout of the display image depending on whether or not the question-and-answer session is conducted. According, to the third embodiment, this configuration makes it possible to change the layout to an appropriate layout in the case where the question-and-answer session is conducted at a seminar.

[4-3. Modification of Layout]

The description is now given of a modification of the layout of the display image according to the fourth embodiment. The description of the fourth embodiment is given that the bird's-eye view layout including the lecturer, the participant, and the materials projected on the screen is used as the layout of the display image, but the present disclosure is not limited to this exemplary configuration.

FIG. 20 is a diagram illustrating a first modification of the layout of a display image according to the third embodiment. FIG. 20 illustrates a participant's bird's-eye view image (also referred to as a whole image).

A display image 70A includes a plurality of participants 72. In one example, in the case where the lecturer asks a question to the participant 72, the layout decision unit 334C can decide on the layout to use only the whole image, which is a bird's-eye view of the participant 72, as the configuration image. This configuration makes it easier to see how the participant 72 is responding to the lecturer's question.

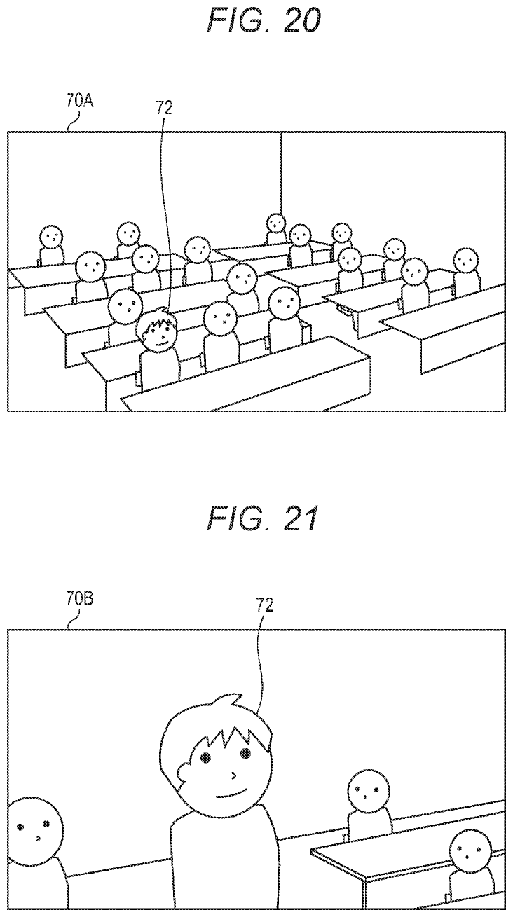

FIG. 21 is a diagram illustrating a second modification of the layout of a display image according to the fourth embodiment. FIG. 21 illustrates a close-up image of the questioner. The close-up image is sometimes called a noticed image.

A display image 70B includes a participant 72. The participant 72 in the display image 70B is a participant who has a question-and-answer session with a lecturer. The participant 72 is, for example, a participant who is asking questions and answering questions with a lecturer. In the case where it is determined that the question-and-answer session initiates between the lecturer 71 and the participant 72, the layout decision unit 334C can decide on the noticed image in which the participant 72 is closed-up as the layout. This makes it easier to see how the participant 72 is conducting questions and answers.

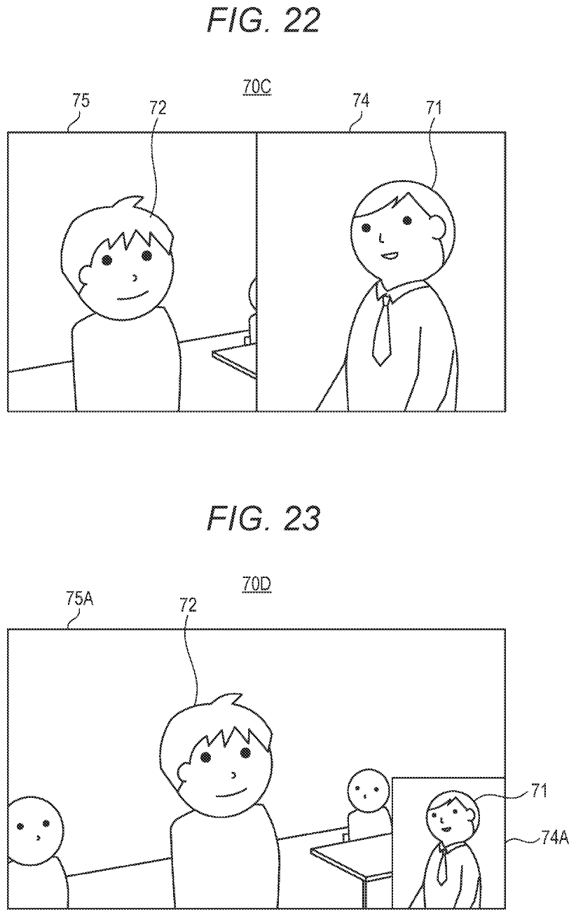

FIG. 22 is a diagram illustrating a third modification of the layout of a display image according to the fourth embodiment. FIG. 22 illustrates the layout of the side-by-side arrangement of a noticed image as a close--up image of the lecturer 71 and a noticed image as a close-up image of the participant 72.

A display image 700 includes a first image display region 74 and a first image display region 75. The image of the lecturer 71 is displayed in the first image display region 74. The lecturer 71 and the participant 72 are having a question-and-answer session. In the case of determining that the question-and-answer session initiates between the lecturer 71 and the participant 72, the layout decision unit 334C can decide on the layout of the side-by-side arrangement, which is the parallel arrangement in which the noticed image with the lecturer 71 being closed-up and the noticed image with the participant 72 being closed-up are displayed side by side. The layout decision unit 334C can decide on the layout of the display image depending on the determination result of at least one of the posture directions of the lecturer 71 or the participant 72 by the action recognition unit 333C. This makes it easier to see how the question-and-answer session is being conducted between the lecturer 71 and the participant 72.

FIG. 23 is a diagram illustrating a fourth modification of the layout of a display image according to the fourth embodiment. FIG. 23 illustrates the layout of the picture-in-picture arrangement of a noticed image as a close-up image of the lecturer 71 and a noticed image as a close-up image of the participant 72.

A display image 70D includes a first image display region 74A and a first image display region 75A. The first image display region 74A is located in the lower right corner of the display image 70D. The first image display region 74A can also be located in the upper left corner, the upper right corner, or the lower left corner of the display image 70D. The first image display region 74A is not limited to the corners of the display image 70D, and can be located at any position including, for example, the central portion of the display image 70D. The layout decision unit 334C can decide on the layout of the display image depending on the determination result of at least one of the posture directions of the lecturer 71 and the participant 72 by the action recognition unit 333B. In the first image display region 74A, a noticed image with the lecturer 71 being closed-up is displayed. The first image display region 75A occupies the whole display image 70D. In the first image display region 75, a noticed image with the participant 72 being closed-up is displayed. This configuration makes it easier to see how the question-and-answer session is being conducted between the lecturer 71 and the participant 72 in the case where it is determined that the participant 72 is speaking when the lecturer 71 and the participant 72 are having a question-and-answer session.

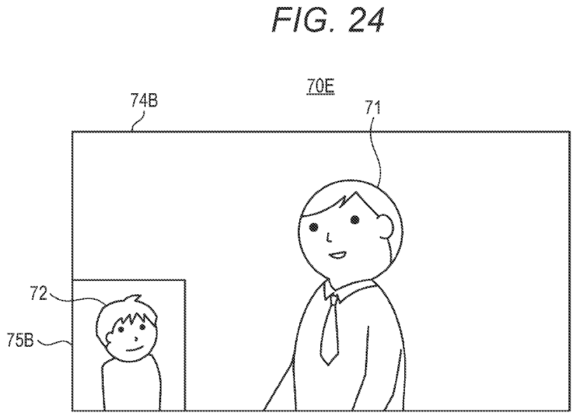

FIG. 24 is a diagram illustrating a fifth modification of the layout of a display image according to the fourth embodiment. FIG. 24 illustrates the layout of the picture-in-picture arrangement which is a superimposition arrangement or a noticed image as a close-up image of the lecturer 71 and a noticed image as a close--up image of the participant 72.

A display image 70E includes a first image display region 73B and a second image display region 75B. The first image display region 74B occupies the whole display image 70E. In the first image display region 74B, a noticed image with the lecturer 71 closed-up is displayed. The second image display region 75B is located in the lower left corner of the display image 70E. The second image display region 75B can also be located in the upper right corner, the upper left corner, or the lower right corner of the display image 70E. The second image display region 75B is not limited to the corners of the display image 70E, and can be located at any position including, for example, the central portion of the display image 705. The layout decision unit 334C can decide on the layout of the display image depending on the determination result of at least one of the posture directions of the lecturer 71 and the participant 72 by the action recognition unit 333B. In the second image display region 755, a noticed image with the participant 72 closed-up is displayed. This configuration makes it easier to see how the question-and--answer session is being conducted between the lecturer 71 and the participant 72 the case where it is determined that the lecturer 71 is speaking when the lecturer 71 and the participant 72 are having a question-and-answer session.

[4-4. Modification of Processing by Information Processing Apparatus]

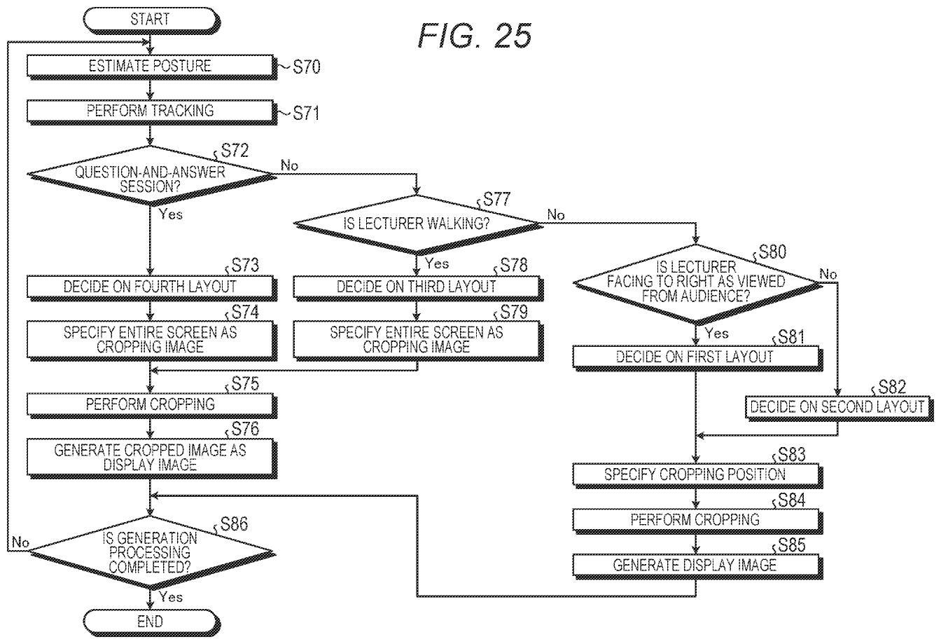

The description is given of a modification of the processing of the information processing apparatus according to the fourth embodiment with reference to FIG. 25. FIG. 25 is a flowchart illustrating an example of the procedure of a modification of processing of the information processing apparatus according to the fourth embodiment.

The second embodiment allows the layout of the display image to be changed depending on the posture direction of the lecturer. The third embodiment allows the layout of the display image to be changed depending on whether or not the lecturer is walking. The fourth embodiment allows the layout of the display image to be changed depending on whether or not the question-and-answer session is conducted. The modification of the fourth embodiment allows for all the determinations of the posture direction of the lecturer, whether or not the lecturer is walking, and whether or not the question-and-answer session is conducted.

The processing of steps S70 to S76 is the same as the processing of steps S50 to S56 illustrated in FIG. 19, so the description thereof is omitted.

The processing of steps S77 to S79 is the same as the processing of steps S32 to S34 illustrated in FIG. 16, so the description thereof is omitted.

The processing of steps S80 to S96 is the same as the processing of steps S22 to S28 illustrated in FIG. 13, so the description thereof is omitted.

### 5. Fifth Embodiment

The description is now given of a fifth embodiment. In the first to fourth embodiments, the display image to be displayed on the display screen is generated. The present disclosure provides the fifth embodiment allowing the display image to be controlled or the display control information to be recorded as metadata.

[5-1. Configuration of Information Processing Apparatus]

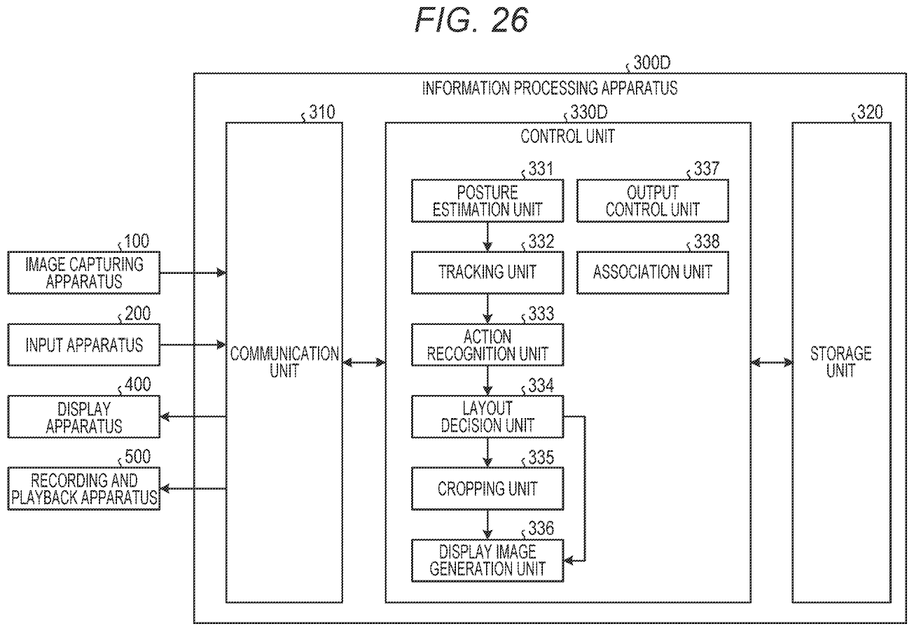

The description is given of the configuration of an information processing apparatus according to the fifth embodiment with reference to FIG. 26. FIG. 26 is a block diagram illustrating a configuration of the information processing apparatus according to the fifth embodiment.

As illustrated in FIG. 26, an information processing apparatus 300D differs from the information processing apparatus 300 illustrated in FIG. 2 in that a control unit 330D includes an output control unit 337 and an association unit 338.

The output control unit 337 controls the output of various types of images to be displayed on the display apparatus 400. In one example, the output control unit 337 controls the display apparatus 400 in such a way that the display apparatus 400 displays a display image synthesized by the display image generation unit 336 on the basis of display control information.

The association unit 338 associates one or more captured images with the display control information. The association unit 338 associates the display control information as metadata with the captured image. The association unit 338 associates the scene information as metadata with the captured image. The association unit 338 can associate the information relating to the posture direction or the layout information with the captured image. The association unit 338 can associate other information with the captured image.

### 6. Hardware Configuration

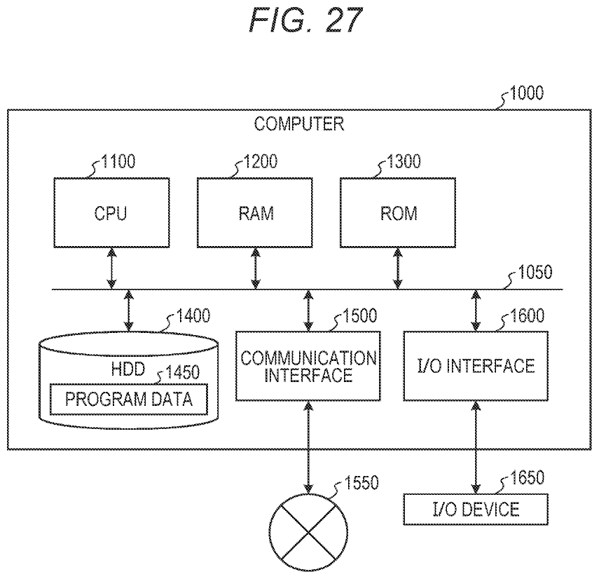

The information processing apparatus 300 to the information processing apparatus 300D according to the embodiments described above are embodied as a computer 1000 having a configuration, for example, as illustrated in FIG. 27. The information processing apparatus 300 according to an embodiment is now described as an example. FIG. 29 is a hardware configuration diagram illustrating an example of the computer 1000. The computer 1000 has a CPU 1100, a RAM 1200, a read-only memory (ROM) 1300, a hard disk drive (HDD) 1400, a communication interface 1500, and an I/O interface 1600. The respective components of the computer 1000 are connected via a bus 1050. Furthermore, the computer 1000 may include a GPU instead of the CPU 1100.

The CPU 1100 operates on the basis of the program stored in the ROM 1300 or the HDD 1400, and controls each component. In one example, the CPU 1100 loads the program stored in the ROM 1300 or the HDD 1400 into the RAM 1200 and executes processing corresponding to various programs.

The ROM 1300 stores a boot program such as a basic input output system (BIOS) executed by the CPU 1100 when the computer 1000 is started, a program that depends on the hardware of the computer 1000, or the like.

The HDD 1400 is a computer-readable recording medium that non temporarily records a program executed by the CPU 1100, data used by such a program, or the like. Specifically, the HDD 1400 is a recording medium for recording a development support program according to the present disclosure, which is an example of program data 1450.

The communication interface 1500 is an interface for the computer 1000 to connect to an external network 1550 (e.g., the Internet). In one example, the CPU 1100 receives data from other devices or transmits data generated by the CPU 1100 to the other devices via the communication interface 1500.

The I/O interface 1600 is an interface for connecting an I/O device 1650 with the computer 1000. In one example, the CPU 1100 receives data from an input device such as a keyboard or mouse via the I/O interface 1600. In addition, the CPU 1100 transmits data to an output device such as a display, a loudspeaker, or a printer via the I/O interface 1600. In addition, the I/O interface 1600 can function as a media interface for reading a program or the like recorded on a predetermined recording medium (media). The media is, for example, an optical recording medium such as digital versatile disc (DVD) or phase change rewritable disk (PD), a magneto-optical recording medium such as magneto-optical disk (MO), a tape medium, a magnetic recording medium, a semiconductor memory, or the like.

In one example, in the case where the computer 1000 functions as the information processing apparatus 300 according to an embodiment described above, the CPU 1100 of the computer 1000 implements each function unit included in the control unit 330 by executing the information processing program loaded on the RAM 1200. In addition, the information processing program according to the present disclosure or the data in the storage unit 320 is stored in the HDD 1400. Moreover, the CPU 1100 reads the program data 1450 from the HDD 1400 and executes the program, but as another example, such a program can be acquired from other devices via the external network 1550.

### 7. Effects

An information processing apparatus 300 according to the present disclosure includes a control unit 330 that generates display control information, which is information regarding display control of a display image corresponding to scene information indicating the scenes of a seminar.

This configuration makes it possible for the information processing apparatus 300 to generate an appropriate video depending on the seminar scene.

The scene information is decided on the basis of one or more captured images. This configuration makes it possible for the information processing apparatus 300 to generate an appropriate video depending on the seminar scene on the basis of one or a plurality of captured images obtained by capturing the circumstance of the seminar.

The scene information is the main-subject action information indicative of the action of the main subject 10 of the seminar. This configuration makes it possible for the information processing apparatus 300 to generate an appropriate video depending on the seminar scene on the basis of the action of the main subject 10 such as the lecturer.

The main-subject 10 action information includes presenting-object-related action information indicating the action performed by the main subject 10 in relation to the presenting object 20 presented at a seminar. This configuration makes it possible for the information processing apparatus 300 to generate an appropriate video depending on the seminar scene on the basis of the presenting-object-related information, such as the materials presented at the seminar.

The scene information is information decided on the basis of a posture of a person. This configuration makes it possible for the information processing apparatus 300 to generate an appropriate video depending on the seminar scene on the basis of the posture of the person included in the scene information.

The person is the main subject 10 or the secondary subject 30 of the seminar. This configuration makes it possible for the information processing apparatus 300 to generate an appropriate video depending on the seminar scene on the basis of the posture of the main subject 10 such as the lecturer and the secondary subject 30 such as the participant.

The display control is to decide a configuration image that is an image that constitutes at least a part of the display image on the basis of the scene information. This configuration makes it possible for the information processing apparatus 300 to decide on the configuration image included in the display image on the basis of the scene information, allowing for the generation of an appropriate video depending on the seminar scene.

The configuration image includes a person image with at least one of the main subject 10 or the secondary subject 30 of the seminar used as a subject. This configuration makes it possible for the information processing apparatus 300 to generate an appropriate video depending on the seminar scene on the basis of the posture of the main subject 10 such as the lecturer and the secondary subject 30 such as the participant.

The scene information is information regarding walking of the main subject 10. The person image is an image with the main subject 10 used as a subject. This configuration makes it possible for the information processing apparatus 300 to decide the image in which the target person is walking as the configuration image of the display image, allowing for the generation of an appropriate video depending on the seminar scene.

The scene information is information indicating a question-and-answer session. The person image is an image with the secondary subject 30 used as a subject. This configuration makes it possible for the information processing apparatus 300 to decide the image in which the target person is in a question-and-answer session as the configuration image of the display image, allowing for the generation of an appropriate video depending on the seminar scene.

The person image includes a whole image or a noticed image. This configuration makes it possible for the information processing apparatus 300 to decide on the whole image or the noticed image including the target person as the configuration image of the display image, allowing for the generation of an appropriate video depending on the seminar scene.

The scene information is presenting-object-related action information indicating the action performed by the main subject 10 of the seminar in relation to the presenting object 20 presented at a seminar. The configuration image corresponding to the scene information includes a presenting object image of the presenting object 20. This configuration makes it possible for the information processing apparatus 300 to decide on the image of the presenting object such as materials projected on the screen as the configuration image of the display image, allowing for the generation of an appropriate video depending on the seminar scene.

The presenting-object-related action information is information indicating the commentary on the presenting object 20 by the main subject 10. This configuration makes it possible for the information processing apparatus 300 to generate an appropriate video depending on the seminar scene on the basis of how the lecturer or the like is giving a commentary.

The presenting-object-related action information is information indicating board writing by the main subject 10. This configuration makes it possible for the information processing apparatus 300 to generate an appropriate video depending on the seminar scene on the basis of how the writing is given on a blackboard or a whiteboard.

The presenting object image includes a writing image including information regarding writing by the board writing. This configuration makes it possible for the information processing apparatus 300 to decide on the writing image including the writing on the board as the configuration image of the display image, allowing for the generation of an appropriate video depending on the seminar scene.

The writing image is an image indicating a writing extraction result obtained by extracting writing from one or more captured images. This configuration makes it possible for the information processing apparatus 300 to extract the contents of the board writing on the basis of the image including the board writing, allowing for the generation of an appropriate video depending on the seminar scene.

The display control is to decide a display arrangement of a configuration image in the display image on the basis of the scene information, the configuration image constituting at least a part of the display image. This configuration makes it possible for the information processing apparatus 300 to decide on the layout of the display image, allowing for the generation of an appropriate video depending on the seminar scene.

The display control is to decide a configuration image in number on the basis of the scene information, the configuration image constituting at least a part of the display image. This configuration makes it possible for the information processing apparatus 300 to select the configuration image that constitutes the display image, allowing for the generation of an appropriate video depending on the seminar scene.

The configuration image is used as a plurality of configuration images. The display arrangement is a parallel arrangement or a superimposition arrangement. This configuration makes it possible for the information processing apparatus 300 to generate the display image, upon having a plurality of configuration images, by arranging the configuration images in parallel or in a superimposed manner, allowing for the generation of an appropriate video depending on the seminar scene.

The scene information includes information indicating a direction of a posture of a person in a person image including the person as a subject in the configuration image. This configuration makes it possible for the information processing apparatus 300 to generate an appropriate video depending on the seminar scene on the basis of the direction of the posture included in the configuration image.

The display control is, in a case where the display image includes a plurality of the configuration images, to decide a display arrangement of a first configuration image in the display image on the basis of a direction of a posture of a person in the person image that is the first configuration image being one of a plurality of the configuration images. This configuration makes it possible for the information processing apparatus 300 to decide on the position where the first configuration image is placed in the display image on the basis of the direction of the posture of the person included in the first configuration image, allowing for the generation of an appropriate video depending on the seminar scene.

The display control is, in a case where the display image includes at least the first configuration image and a second configuration image that are configuration images, to decide on the display arrangement in such a way that the direction of the posture of the person in the person image that is the first configuration image corresponds to a positional relationship of a center of the second configuration image relative to a position of a center of the first configuration image in the display image. This configuration makes it possible for the information processing apparatus 300 to decide on the position for arranging the first configuration image and the second configuration image in such a way that the direction of the posture of the person included in the first image faces the center of the second image, allowing for the generation of an appropriate video depending on the seminar scene.

The second configuration image is a presenting object image of the presenting object 20 presented at the seminar. This configuration makes it possible for the information processing apparatus 300 to decide on the layout in such a way that the direction of the posture of the person included in the first configuration image faces the presenting object 20 such as materials projected on the screen included in the second configuration image, allowing for the generation of an appropriate video depending on the seminar scene.

The control unit 330 associates the display control information with one or more captured images. This configuration makes it possible for the information processing apparatus 300 to analyze the generated display control information, so the use of the analysis result allows for the generation of an appropriate video depending on the seminar scene.

The control unit 330 generates the display image on the basis of the display control information. This configuration makes it possible for the information processing apparatus 300 to perform various types of display control, allowing for the generation of an appropriate video depending on the seminar scene.

Further, the effects described in this specification are merely illustrative or exemplified effects and are not necessarily limitative. That is, with or in the place of the above effects, the technology according to the present disclosure may achieve other effects that are clear to those skilled in the art on the basis of the description of this specification.

Additionally, the present technology may also be configured as below.

(1)

An information processing apparatus including: a control unit configured to generate display control information used as information regarding display control of a display image corresponding to scene information indicating a scene of a seminar.

(2)

The information processing apparatus according to (1), in which

the scene information is decided on the basis of one or more captured images.

(3)

The information processing apparatus according to (1) or (2), in which

the scene information is main-subject action information indicating an action of a main subject of the seminar.

(4)

The information processing apparatus according to (3), in which

the main-subject action information includes presenting-object-related action information indicating an action performed by the main subject in relation to a presenting object presented at the seminar.

(5)

The information processing apparatus according to any one of (1) to (4), in which

the scene information is information decided on the basis of a posture of a person.

(6)

The information processing apparatus according to (5), in which

the person is a main subject or a secondary subject of the seminar.

(7)

The information processing apparatus according to any one of (1) to (6), in which

the display control is

to decide a configuration image that is an image that constitutes at least a part of the display image on the basis of the scene information.

(8)

The information processing apparatus according to (7), in which

the configuration image includes a person image with at least one of a main subject or a secondary subject of the seminar used as a subject.

(9)

The information processing apparatus according to (8), in which

the scene information is information regarding walking of the main subject, and

the person image is an image with the main subject used as a subject.

(10)

The information processing apparatus according to (8), in which

the scene information is information indicating a question-and-answer session, and

the person image is an image with the secondary subject used as a subject.

(11)

The information processing apparatus according to any one of (8) to (10), in which

the person image includes a whole image or a noticed image.

(12)

The information processing apparatus according to (7), in which

the scene information is presenting-object-related action information indicating an action performed by a main subject of the seminar in relation to a presenting object presented at the seminar, and the configuration image corresponding to the scene information includes a presenting object image of the presenting object.

(13)

The information processing apparatus according to (12), in which

the presenting-object-related action information is information indicating a commentary on the presenting object by the main subject.

(14)

The information processing apparatus according to (12) or (13), in which

the presenting-object-related action information is information indicating board writing by the main subject.

(15)

The information processing apparatus according to (14), in which

the presenting object image includes a writing image including information regarding writing by the board writing.

(16)

The information processing apparatus according to (15), in which

the writing image is an image indicating a writing extraction result obtained by extracting writing from one or more captured images.

(17)

The information processing apparatus according to any one of (1) to (16), in which

the display control is

to decide a display arrangement of a configuration image in the display image on the basis of the scene information, the configuration image constituting at least a part of the display image.

(18)

The information processing apparatus according to (17), in which

the display control is

to decide a configuration image in number on the basis of the scene information, the configuration image constituting at least a part of the display image.

(19)

The information processing apparatus according to (18), in which

the configuration image is used as a plurality of configuration images, and

the display arrangement is a parallel arrangement or a superimposition arrangement.

(20)

The information processing apparatus according to (19), in which

the scene information includes information indicating a direction of a posture of a person in a person image including the person as a subject in the configuration image.

(21)

The information processing apparatus according to (19), in which

the display control is,

in a case where the display image includes a plurality of the configuration images,

to decide a display arrangement of a first configuration image in the display image on the basis of a direction of a posture of a person in the person image that is the first configuration image being one of a plurality of the configuration images.

(22)

The information processing apparatus according to (21), in which

the display control is,

in a case where the display image includes at least the first configuration image and a second configuration image that are configuration images,

to decide on the display arrangement in such a way that the direction of the posture of the person in the person image that is the first configuration image corresponds to a positional relationship of a center of the second configuration image relative to a position of a center of the first configuration image in the display image.

(23)

The information processing apparatus according to (22), in which

the second configuration image is a presenting object image of a presenting object presented at the seminar.

(24)

The information processing apparatus according to any one of (1) to (23), in which

the control unit associates the display control information with one or more captured images.

(25)

The information processing apparatus according to any one of (1) to (24), in which

the control unit generates the display image on the basis of the display control information.

(26)

An information processing method causing a computer to execute processing including:

generating display control information used as information regarding display control of a display image corresponding to scene information indicating a scene of a seminar.

(27)

An information processing program causing a computer to execute processing including:

generating display control information used as information regarding display control of a display image corresponding to scene information indicating a scene of a seminar.

### REFERENCE SIGNS LIST

100 Image capturing apparatus
200 Input apparatus
300, 300A, 300B, 300C, 300D Information processing apparatus
310 Communication unit
320 Storage unit
330 Control unit
331 Posture estimation unit
332 Tracking unit
333 Action recognition unit
334 Layout decision unit
335 Cropping unit
336 Display image generation unit
337 Output control unit
338 Association unit
400 Display apparatus
500 Recording and playback apparatus

1. An information processing apparatus comprising: a control unit configured to generate display control information used as information regarding display control of a display image corresponding to scene information indicating a scene of a seminar.

2. The information processing apparatus according to claim 1, wherein
the scene information is decided on a basis of one or more captured images.

3. The information processing apparatus according to claim 1, wherein
the scene information is main-subject action information indicating an action of a main subject of the seminar.

4. The information processing apparatus according to claim 3, wherein
the main-subject action information includes presenting-object-related action information indicating an action performed by the main subject in relation to a presenting object presented at the seminar.

5. The information processing apparatus according to claim 1, wherein
the scene information is information decided on a basis of a posture of a person.

6. The information processing apparatus according to claim 5, wherein
the person is a main subject or a secondary subject of the seminar.

7. The information processing apparatus according to claim 1, wherein
the display control is
to decide a configuration image that is an image that constitutes at least a part of the display image on a basis of the scene information.

8. The information processing apparatus according to claim 7, wherein
the configuration image includes a person image with at least one of a main subject or a secondary subject of the seminar used as a subject.

9. The information processing apparatus according to claim 8, wherein
the scene information is information regarding walking of the main subject, and
the person image is an image with the main subject used as a subject.

10. The information processing apparatus according to claim 8, wherein
the scene information is information indicating a question-and-answer session, and
the person image is an image with the secondary subject used as a subject.

11. The information processing apparatus according to claim 8, wherein
the person image includes a whole image or a noticed image.

12. The information processing apparatus according to claim 7, wherein
the scene information is presenting-object-related action information indicating an action performed by a main subject of the seminar is relation to a presenting object presented at the seminar, and the configuration image corresponding to the scene information includes a presenting object image of the presenting object.

13. The information processing apparatus according to claim 12, wherein
the presenting-object-related action information is information indicating a commentary on the presenting object by the main subject.

14. The information processing apparatus according to claim 12, wherein
the presenting-object-related action information is information indicating board writing by the main subject.

15. The information processing apparatus according to claim 14, wherein
the presenting object image includes a writing image including information regarding writing by the board writing.

16. The information processing apparatus according to claim 15, wherein
the writing image is an image indicating a writing extraction result obtained by extracting writing from one or more captured images.

17. The information processing apparatus according to claim 1, wherein
the display control is
to decide a display arrangement of a configuration image in the display image on a basis of the scene information, the configuration image constituting at least a part of the display image.

18. The information processing apparatus according to claim 1, wherein
the display control is
to decide a configuration image in number on a basis of the scene information, the configuration image constituting at least a part of the display image.

19. The information processing apparatus according to claim 17, wherein
the configuration image is used as a plurality of configuration images, and
the display arrangement is a parallel arrangement or a superimposition arrangement.

20. The information processing apparatus according to claim 17, wherein
the scene information includes information indicating a direction of a posture of a person is a person image including the person as a subject in the configuration image.

21. The information processing apparatus according to claim 20, wherein
the display control is,
in a case where the display image includes a plurality of the configuration images,
to decide a display arrangement of a first configuration image in the display image on a basis of a direction of a posture of a person in the person image that is the first configuration image being one of a plurality of the configuration images.

22. The information processing apparatus according to claim 21, wherein
the display control is,
in a case where the display image includes at least the first configuration image and a second configuration image that are configuration images,
to decide on the display arrangement in such a way that the direction of the posture of the person in the person image that is the first configuration image corresponds to a positional relationship of a center of the second configuration image relative to a position of a center of the first configuration image in the display image.

23. The information processing apparatus according to claim 22, wherein
the second configuration image is a presenting object image of a presenting object presented at the seminar.

24. The information processing apparatus according to claim 1, wherein
the control unit associates the display control information with one or more captured images.

25. The information processing apparatus according to claim 1, wherein
the control unit generates the display image on a basis of the display control information.

26. An information processing method causing a computer to execute processing comprising:
generating display control information used as information regarding display control of a display image corresponding to scene information indicating a scene of a seminar.

27. An information processing program causing a computer to execute processing comprising:
generating display control information used as information regarding display control of a display image corresponding to scene information indicating a scene of a seminar.
